(19) United States
(12) Patent Application Publication
(10) Pub. No.: US 2026/0126707 A1
(43) Pub. Date: May 7, 2026

(54) IMAGING SYSTEM FOR PROTECTIVE EYEWEAR

(71) Applicant: GoPro, Inc., San Mateo, CA (US)

(72) Inventors: Nicholas D. Woodman, Big Sky, MT (US); Joshua Todd Druker, Redwood City, CA (US); Huy Phuong Nguyen, Alpine, UT (US); Bessy Wen-Han Liang, San Jose, CA (US)

(21) Appl. No.: 19/089,496

(22) Filed: Mar. 25, 2025

Related U.S. Application Data
(60) Provisional application No. 63/569,972, filed on Mar. 26, 2024.
(60) Provisional application No. 63/675,307, filed on Jul. 25, 2024.
(60) Provisional application No. 63/688,474, filed on Aug. 29, 2024.
(60) Provisional application No. 63/716,008, filed on Nov. 4, 2024.
(60) Provisional application No. 63/771,225, filed on Mar. 13, 2025.

(51) Int. Cl. G03B 17/56; G02C 11/00

(52) U.S. Cl. CPC G03B 17/561; G02C 11/10; G03B 17/566; G02C 2200/02; G03B 2217/007

(57) ABSTRACT

An imaging system for protective eyewear that includes an image capture device configured for removable coupling to and from a frame of the protective eyewear and a control module configured to power the image capture device and configured for removable coupling to and from a strap of the protective eyewear. The image capture device includes a connecting portion that extends into the frame to removably couple the image capture device to the frame. The control module is spaced apart from the image capture device when the image capture device and the control module are coupled to the protective eyewear.

### CROSS-REFERENCE TO RELATED APPLICATION(S)

This application claims priority to and the benefit of U.S. Provisional Ser. No. 63/569,972, filed Mar. 26, 2024, U.S. Provisional Ser. No. 63/675,307, filed Jul. 25, 2024, U.S. Provisional Ser. No. 63/688,474, filed Aug. 29, 2024, U.S. Provisional Ser. No. 63/716,008, filed Nov. 4, 2024, and U.S. Provisional Ser. No. 63/771,225, filed Mar. 13, 2025, the entire disclosures of which are hereby incorporated by reference.

### TECHNICAL FIELD

This disclosure relates to an imaging system, and more particularly, to an imaging system adapted for use with protective eyewear.

### BACKGROUND

Imaging devices capture images and videos using one or more lenses that gather light to be focused onto an image sensor. Ease of use and convenience of mounting or carrying imaging devices is important to users that record both day-to-day and high-intensity activities. By way of example, users may require mounting or carrying imaging devices during high-intensity activities such as skiing, snowboarding, and biking. Smaller devices with simpler interfaces may attract a wider number of users. However, providing extensive processing, storage, and/or other capabilities to smaller imaging devices may be difficult with tight packaging constraints and limited interface options. An imaging device that is easy to mount in a variety of ways, which is small and unobtrusive, and that includes an easy-to-use interface may beneficially improve a user's experience with the imaging device, especially during high-intensity activities.

### SUMMARY

In one implementation, an imaging system for protective eyewear is disclosed. The imaging system for protective eyewear includes an image capture device configured for removable coupling to and from an exterior of the protective eyewear and a battery configured to power the image capture device and configured for removable coupling to and from the protective eyewear. The battery is spaced apart from the image capture device when the image capture device and the battery are coupled to the protective eyewear.

In certain implementations, the image capture device and the battery may be interchangeable such that the image capture device and the battery are configured to removably couple to the exterior of the protective eyewear at one or more of the same locations.

In certain implementations, the imaging system may include an attachment bracket configured to removably couple the image capture device to the protective eyewear and extend along an exterior surface of the protective eyewear between a first side of the protective eyewear and a second side of the protective eyewear that opposes the first side. The attachment bracket may include a first side portion that is configured to abut the first side of the protective eyewear and a second side portion that is configured to abut the second side of the protective eyewear.

The first side portion and the second side portion of the attachment bracket may each include a magnetic portion such that the image capture device may be magnetically coupled to the first side portion and the battery may be magnetically coupled to the second side portion, or vice versa. The first side portion and the second side portion of the attachment bracket may be electrically connected via wiring extending through the attachment bracket between the first side portion and the second side portion. Additionally, the image capture device may be powered by the battery via the wiring when the image capture device and the battery are magnetically coupled to the first side portion and the second side portion, respectively. Moreover, the image capture device and the battery may be interchangeable such that the image capture device and the battery may be configured to be coupled to both the first side portion and the second side portion of the attachment bracket.

In certain implementations, the imaging system may include a lens assembly located at least partially within a body of the image capture device, one or more microphones, one or more speakers, and a light configured to illuminate an area external to the image capture device. The protective eyewear may include a frame and a lens secured within the frame, whereby the lens assembly may be configured to extend outward from the protective eyewear beyond an entirety of an exterior surface of the lens.

In certain implementations, the imaging system may include an indicator light coupled to the protective eyewear and configured to indicate a status of the image capture device. The indicator light may be positioned within an interior portion of the protective eyewear such that the indicator light may be viewable by a user wearing the protective eyewear. The indicator light may be electrically connected to the image capture device, the battery, or both.

In certain implementations, the protective eyewear may include a strap coupled to a frame to secure the protective eyewear to a head of a user. The battery may be coupled to the strap and the image capture device may be coupled to the frame. The imaging system may include a user interface that may be coupled to the strap of the protective eyewear. Additionally, the user interface may be spaced apart from the battery and the image capture device. The user interface, the battery, and the image capture device may be electrically connected by wiring routed through the strap and the frame of the protective eyewear.

In another implementation, an imaging system for protective eyewear is disclosed. The protective eyewear includes an image capture device and configured for removable coupling to and from an exterior of the protective eyewear. The image capture device is configured for removable coupling to and from an exterior of the battery.

In certain implementations, the image capture device may include a lens assembly located at least partially within a body of the image capture device and one or more buttons configured to receive a user input from a user.

In certain implementations, the battery may include one or more electrical contacts that are configured to contact a portion of the image capture device to power the image capture device through the one or more electrical contacts. The battery may also include a first magnetic portion configured to magnetically couple the battery to a frame of the protective eyewear and a second magnetic portion configured to magnetically couple the image capture device to the battery. The image capture device may be configured to magnetically couple to the battery such that the battery may be positioned between the image capture device and the frame of the protective eyewear. The image capture device may be free of direct contact with the protective eyewear.

In another implementation, an imaging system for protective eyewear is disclosed. The imaging system includes an image capture device configured to be disposed in a frame of the protective eyewear, a battery configured to power the image capture device and configured for removable coupling to and from the protective eyewear, and a computing device configured to control operation of the image capture device and configured for removable coupling to and from the protective eyewear. The battery is spaced apart from the image capture device. Additionally, the computing device is spaced apart from the image capture device and the battery.

In certain implementations, the battery may include a user interface configured to receive an input from a user. The computing device may be configured to control operation of the image capture device based upon the input from the user.

In certain implementations, the protective eyewear may include a strap coupled to the frame of the protective eyewear to secure the protective eyewear to a head of a user. The computing device and the battery may be configured to removably couple to the strap. The battery may be coupled to or integrally formed with a buckle that may be movably coupled to the strap. The buckle may be configured to adjust a length of the strap. The computing device may be coupled to or integrally formed with a buckle that may be movably coupled to the strap. The buckle may be configured to adjust a length of the strap. Additionally, the strap may define a channel and the imaging system may include wiring that is routed through the channel to electrically connect the image capture device, the battery, and the computing device. The wiring may be routed through the channel between the computing device and the image capture device. A length of the wiring may be configured to change based upon movement of the buckle.

In one implementation, an imaging system for protective eyewear is disclosed. The imaging system includes an image capture device configured for removable coupling to and from a frame of the protective eyewear and a control module configured to power the image capture device and configured for removable coupling to and from a strap of the protective eyewear. The image capture device includes a connecting portion that extends into the frame to removably couple the image capture device to the frame. The control module is spaced apart from the image capture device when the image capture device and the control module are coupled to the protective eyewear.

In some configurations, the image capture device may include a lens assembly located at least partially within a body of the image capture device, one or more microphones, one or more speakers, and a light configured to illuminate an area external to the image capture device. The protective eyewear may also include a lens secured within the frame. The lens assembly may be configured to extend outward from the protective eyewear beyond an entirety of an exterior surface of the lens.

In some configurations, the strap may be coupled to the frame and configured to secure the protective eyewear to a head of a user.

In some configurations, the control module may include a user interface to control operation of the image capture device.

In some configurations, the control module may include one or more clip portions that are configured to secure the control module to the strap. A position of the control module along the strap may be adjustable via the clip portions. The control module may include a housing, whereby the one or more clips portions may be formed with the housing. Additionally, the housing may define a cavity therein that is accessible via an openable access panel of the housing. A power module may be disposed in the cavity of the housing and configured to power the image capture device.

In some configurations, the control module may include one or more contacts that are configured to electrically connect an accessory to the control module. The accessory may be at least one of a cellular network module, a power module, or a peer-to-peer communication module. The one or more contacts may be configured to electrically and mechanically connect the accessory to the control module.

In some configurations, the connecting portion may be configured to rotatably couple the image capture device to the frame such that the image capture device is configured to rotate with respect to the frame when the image capture device is coupled to the frame. The connecting portion may include one or more teeth that are configured to mesh with teeth of the frame and establish geared rotation of the image capture device with respect to the frame. The frame may define a receiving portion therein, and the teeth of the frame may be disposed within the receiving portion such that, when the connecting portion is inserted into the receiving portion, the teeth of the receiving portion mesh with the teeth of the connecting portion.

In another implementation, an imaging system for protective eyewear is disclosed. The imaging system includes an image capture device configured for removable coupling to and from a frame of the protective eyewear, a control module configured to power the image capture device via wiring connecting the control module to the image capture device, and a strap configured for removable coupling to and from the frame of the protective eyewear. The control module is removably coupled to the strap and spaced apart from the image capture device when the image capture device is coupled to the frame of the protective eyewear.

In some configurations, the wiring may be routed through an interior channel defined by the strap and located between the image capture device and the control module.

In some configurations, the strap may be configured to be removably coupled to the frame of the protective eyewear and interchangeable with arms that are configured to be removably coupled to the frame.

In some configurations, the strap may be configured to removably couple to one or more quick-release mechanisms of the frame of the protective eyewear.

In some configurations, the strap may be configured to secure the protective eyewear to a head of a user. The image capture device may be configured for positioning near a left side or right side of the head of the user. The control module may be configured for positioning near a back of the head of the user.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A-1B are isometric views of an example of an image capture apparatus.

FIG. 2A-2B are isometric views of another example of an image capture apparatus.

FIG. 3 is a top view of another example of an image capture apparatus.

FIG. 4A-4B are isometric views of another example of an image capture apparatus.

FIG. 5 is a block diagram of electronic components of an image capture apparatus.

FIG. 6A is a perspective view of an example of an imaging system for protective eyewear.

FIG. 6B is a perspective view of another example of an imaging system for protective eyewear.

FIG. 7A is a top-down view of an example of an imaging system for protective eyewear.

FIG. 7B is a top-down view of another example of an imaging system for protective eyewear.

FIG. 7C is a top-down view of another example of an imaging system for protective eyewear.

FIG. 8 is a top-down view of an example of a system for protective eyewear that is free of an image capture device.

FIG. 9 is a close-up perspective view of an indicator light of an imaging system for protective eyewear.

FIG. 10A is a front perspective view of another example of an imaging system for protective eyewear.

FIG. 10B is a rear perspective view of the imaging system of FIG. 10B.

FIG. 11A is a top-down view of another example of an imaging system for protective eyewear.

FIG. 11B is a perspective view of the imaging system shown in FIG. 11A.

FIG. 12 is a perspective view of another example of an imaging system for protective eyewear.

FIG. 13A is cross-section 13A-13A of the imaging system shown in FIG. 12.

FIG. 13B is another example of a cross-section of the imaging system show in FIG. 12.

FIG. 14 is a close-up, perspective view of the imaging system shown in FIG. 12.

FIG. 15A is a perspective view of an example of an imaging system for protective eyewear prior to coupling the imaging system to the protective eyewear.

FIG. 15B is another perspective view of the imaging system shown in FIG. 15A after coupling the imaging system to the protective eyewear.

FIG. 15C is a top-down view of the imaging system and the protective eyewear shown in FIGS. 15A and 15B.

FIG. 16A is a top-down view of an example of an imaging system for protective eyewear.

FIG. 16B is a side view of the imaging system shown in FIG. 16A.

FIG. 16C is a rear view of the imaging system shown in FIGS. 16A and 16B.

FIG. 16D is a front view of the imaging system shown in FIGS. 16A-16C.

FIG. 17 is an example of the imaging system of FIGS. 16A-16D coupled to a structure.

FIG. 18 is a front view of an example of a mounting plate for the imaging system shown in FIG. 17.

FIG. 19A is a perspective view of an example of an imaging system for protective eyewear.

FIG. 19B is another perspective view of the imaging system shown in FIG. 15A after removing a strap of the protective eyewear.

FIG. 20 is an illustration of an imaging system with a mounting component.

FIG. 21 is an illustration of a visor including a mounting component configured to couple to the mounting component of the imaging system of FIG. 20.

FIG. 22 is an illustration of another visor including a mounting component configured to couple to the mounting component of the imaging system of FIG. 20.

FIG. 23 is an illustration of the imaging system of FIG. 20 configured to couple to a visor in a first configuration.

FIG. 24 is an illustration of the imaging system of FIG. 20 coupled to a visor in a second configuration.

FIG. 25 is an illustration of another imaging system coupled to a visor in a third configuration.

FIG. 26 is an illustration of another imaging system coupled to a visor and a power source.

FIG. 27 is an illustration of another imaging system coupled to a visor, a power source, and a remote computing device.

FIG. 28 is a perspective view of an example of an imaging system for protective eyewear.

FIG. 29A is a front view of an attachment for an imaging system.

FIG. 29B is another front view of the attachment shown in FIG. 29A.

FIG. 30 is a side view of an imaging system configured to couple to the attachment shown in FIGS. 29A and 29B.

FIG. 31 is a perspective view of another attachment for an imaging system.

FIG. 32 is a perspective view of another attachment for coupling an imaging system to protective eyewear.

FIG. 33 is a perspective view of another attachment for coupling an imaging system to an arm of protective eyewear.

FIG. 34 is a perspective view of another attachment for coupling an imaging system to opposing arms of protective eyewear.

FIG. 35 is a perspective view of another attachment for an imaging system that includes a buckle and a base.

FIG. 36 is a perspective view of another attachment for an imaging system that includes a socket.

FIG. 37 is a perspective view of another attachment that includes a strap for securing an imaging system to a user.

FIG. 38A is a front view of another attachment for an imaging system.

FIG. 38B is a side view of the attachment shown in FIG. 38A.

FIG. 39 is side view of another attachment for coupling an imaging system to a pole.

FIG. 40 is a top-down view of another attachment that includes a mouthpiece.

FIG. 41 is a front view of another attachment for an imaging system.

FIG. 42 is a side view of an example of an imaging system for coupling to an earmuff of a helmet.

### DETAILED DESCRIPTION

The present implementations describe an imaging system for protective eyewear. The imaging system may be removably coupled to the protective eyewear and/or the imaging system may be integrated into the protective eyewear. By way of example, the imaging system may include one or more components, such as an image capture device (e.g., a camera), a battery, a user interface, or a combination thereof that may be coupled to or integrated into goggles (e.g., ski goggles, motocross goggles, etc.), sunglasses, glasses (e.g., prescription glasses, nonprescription glasses, readers, glasses configured for activation (e.g., configured for wear when playing sport), etc.), safety glasses, or other types of protective eyewear. As a result, the imaging system may enable seamless capture of high-quality images in situations that would otherwise require a more complicated process for image capturing or discourage image capturing altogether. By way of example, the present implementations may facilitate capturing high-quality images by a user (e.g., an athlete) during participating in high-performance recreational activities (e.g., sports). In another example, the present implementations may facilitate capturing high-quality images by a user participating in high-intensity or otherwise challenging activities, such as construction, manufacturing, law enforcement, or other activities. As a result, the user may no longer need to hold the image capture device to capture images.

The imaging system described herein may further be adapted for mounting to helmet. For example, the imaging system may be modular such that the imaging system may be coupled to protective eyewear (e.g., goggles) as described and may also be coupled to a visor and/or an earmuff of a helmet. The imaging system may be configured for use with any type of helmet, such as a ski helmet, motocross helmet, dirt bike helmet, skydiving helmet, other type of helmet, or a combination thereof. For example, the imaging system may include or may be removably coupled to an attachment (e.g., an attachment mechanism or accessory), whereby the attachment may be coupled to the protective eyewear, the helmet, or both. As such, the imaging system may be adapted for use with a variety of wearable items.

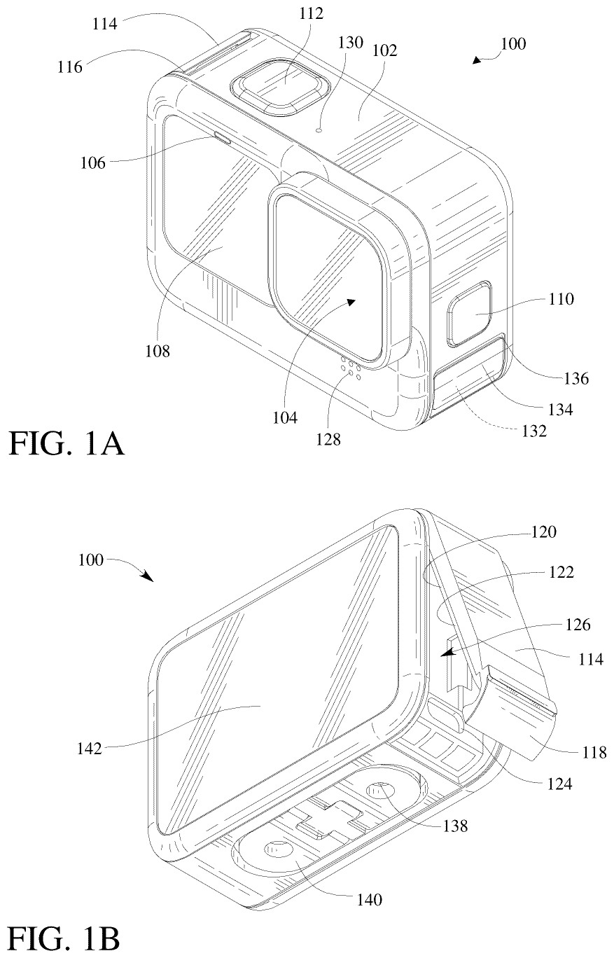

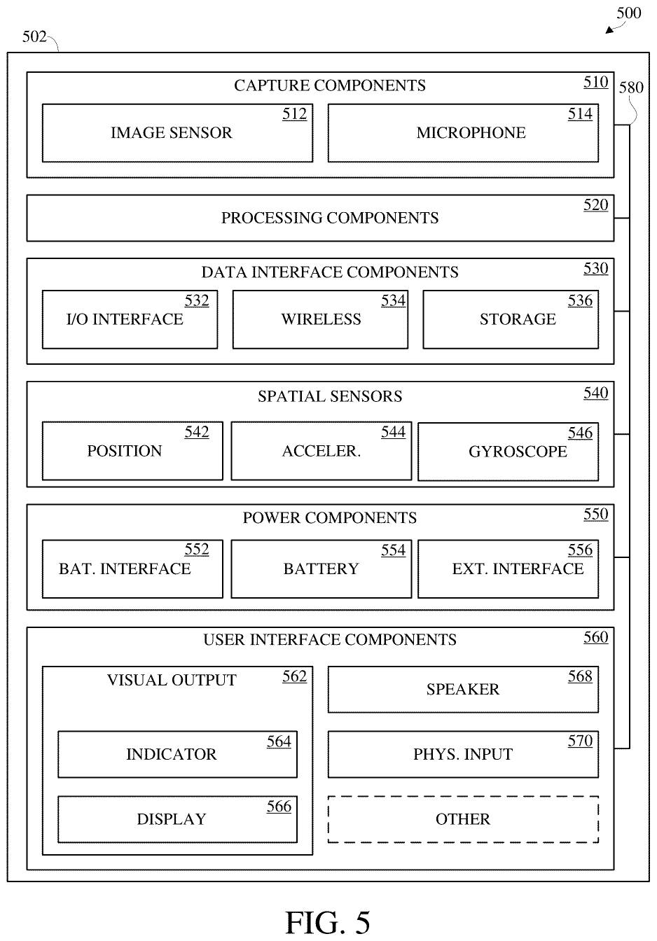

FIG. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIG. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIG. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIG. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

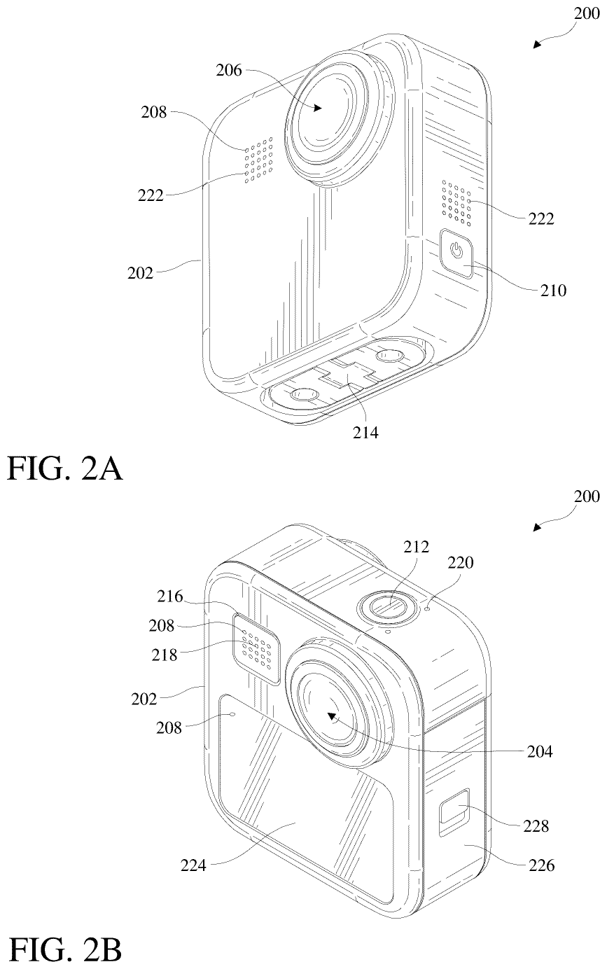

FIG. 2A-2B illustrate another example of an image capture apparatus 200. The image capture apparatus 200 is similar to the image capture apparatus 100 shown in FIG. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIG. 2A-2B is an example, other arrangements of elements may be used.

The body 202 of the image capture apparatus 200 may be similar to the body 102 shown in FIG. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIG. 2A-2B, the image capture apparatus 200 may include other indictors structured on respective surfaces of the body 202.

As shown in FIG. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIG. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIG. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIG. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIG. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIG. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

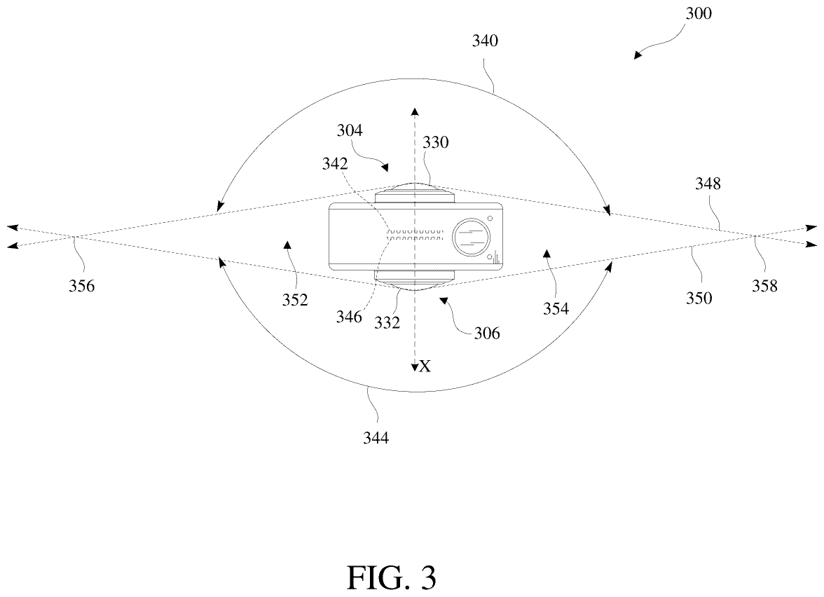

FIG. 3 is a top view of an image capture apparatus 300. The image capture apparatus 300 is similar to the image capture apparatus 200 of FIG. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 detects a first hyper-hemispherical image plane from light entering the first lens 330. The second image sensor 346 detects a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously detected by the respective image sensors 342, 346 may be combined to form a combined image, such as a spherical image. Generating a combined image may include correlating the overlapping regions detected by the respective image sensors 342, 346, aligning the captured fields-of-view 340, 344, and stitching the images together to form a cohesive combined image. Stitching the images together may include correlating the overlap points 356, 358 with respective locations in corresponding images detected by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images detected by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

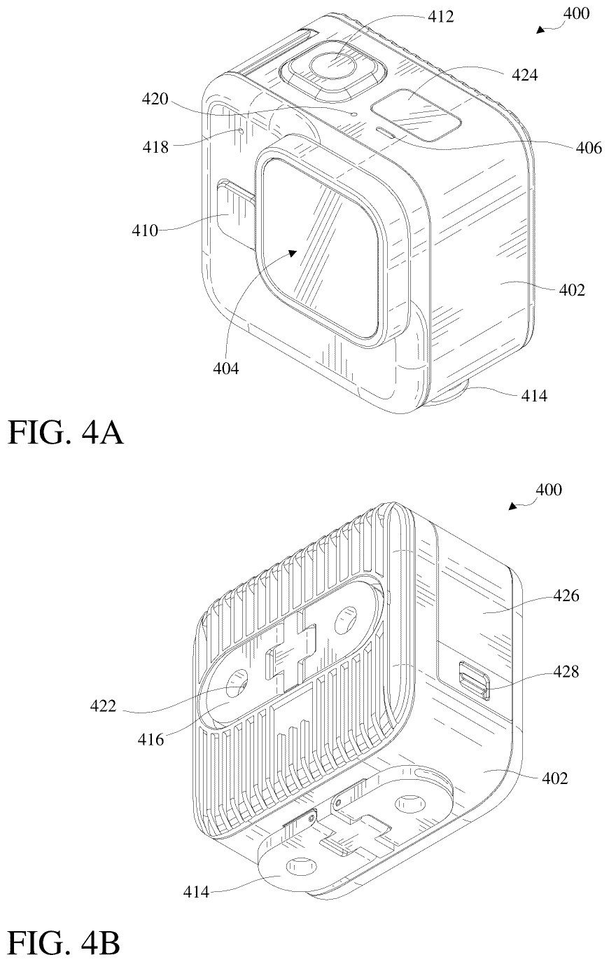

FIG. 4A-4B illustrate another example of an image capture apparatus 400. The image capture apparatus 400 is similar to the image capture apparatus 100 shown in FIG. 1A-1B and to the image capture apparatus 200 shown in FIG. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIG. 4A-4B is an example, other arrangements of elements may be used.

The body 402 of the image capture apparatus 400 may be similar to the body 102 shown in FIG. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIG. 4A, the image capture apparatus 400 may include other indictors structured on respective surfaces of the body 402.

As shown in FIG. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIG. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIG. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIG. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIG. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIG. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIG. 1A-1B, the image capture apparatus 200 shown in FIG. 2A-2B, the image capture apparatus 300 shown in FIG. 3, or the image capture apparatus 400 shown in FIG. 4A-4B, may be implemented as shown in FIG. 5.

The image capture apparatus 500 includes a body 502. The body 502 may be similar to the body 102 shown in FIG. 1A-1B, the body 202 shown in FIG. 2A-2B, or the body 402 shown in FIG. 4A-4B. The body 502 includes electronic components such as capture components 510, processing components 520, data interface components 530, spatial sensors 540, power components 550, user interface components 560, and a bus 580.

The capture components 510 include an image sensor 512 for detecting images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 detects light as image data and conveys the image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with image detection by the image sensor 512. The microphone 514 may detect sound to receive audible commands to control the image capture apparatus 500. The microphone 514 may be similar to the microphones 128, 130, 132 shown in FIG. 1A-1B, the audio components 218, 220, 222 shown in FIG. 2A-2B, or the audio components 418, 420, 422 shown in FIG. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIG. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIG. 2A-2B, or the audio components 418, 420, 422 shown in FIG. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may detect, receive, or otherwise process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

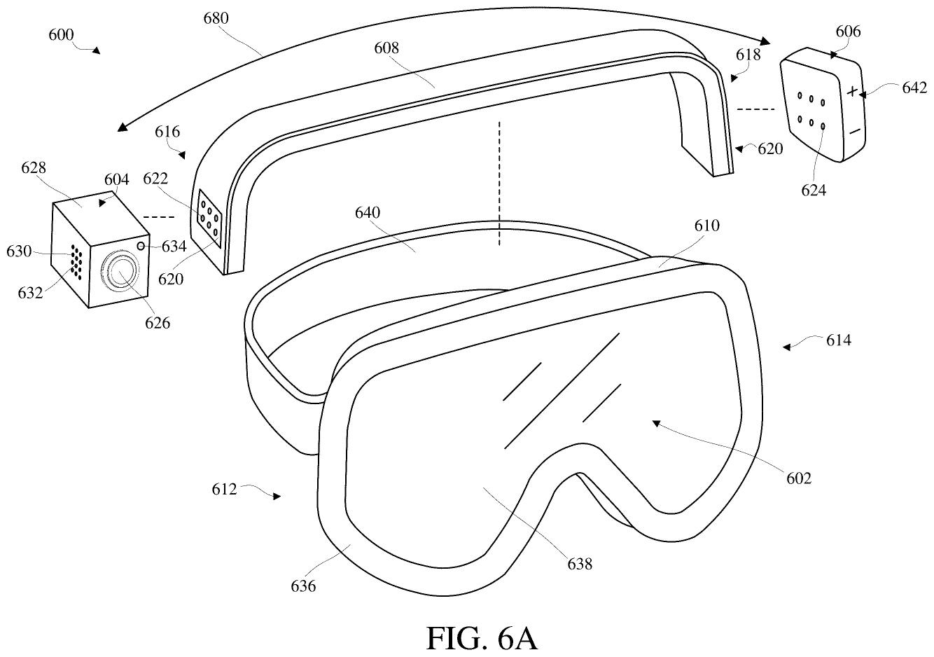

FIG. 6A illustrates a perspective view of an imaging system 600. The imaging system 600 may be configured for removably coupling to and from an exterior of protective eyewear 602. By way of example, the imaging system 600 may be configured to removably couple to any type of protective eyewear, such as ski or snowboard goggles, motorcycling goggles, motocross goggles, sunglasses, skydiving goggles, other types of protective eyewear, or a combination thereof. As such, the imaging system 600 may not be limited to use with or as part of any particular type of protective eyewear. For illustrative purposes, the protective eyewear 602 shown in FIG. 6A is a pair of goggles configured to be worn be a skier or snowboarder.

The imaging system 600 may include an image capture device 604 and a battery 606 configured to power the image capture device 604. The image capture device 604 and the battery 606 may be removably coupled to the protective eyewear by an attachment bracket 608. That is, the image capture device 604 and the battery 606 may be removably coupled to the attachment bracket 608 and the attachment bracket 608 may be removably coupled to the protective eyewear 602. For example, as shown in FIG. 6A, the attachment bracket 608 may be configured to removably couple the image capture device 604 and the battery 606 to the protective eyewear 602 by extending along an exterior surface of the protective eyewear 602, such as a top surface 610 of the protective eyewear 602.

The attachment bracket 608 may extend along the top surface 610 of the protective eyewear 602 between a first side 612 of the protective eyewear 602 and a second side 614 of the protective eyewear 602 that opposes the first side 612. For example, the attachment bracket 608 may include a first side portion 616 that is configured to abut the first side 612 of the protective eyewear 602 and a second side portion 618 that is configured to abut the second side 614 of the protective eyewear 602. As a result, the attachment bracket 608 may removably couple to the top surface 610, the first side 612, and the second side 614 of the protective eyewear 602, thereby allowing a user (e.g., a skier or a snowboarder) to easily connect and disconnect the imaging system 600 from the protective eyewear 602. Additionally, the attachment bracket 608 may be adapted for use with a variety of different types of protective eyewear 602, thereby facilitating more universal use of the imaging system 600.

As discussed above, the image capture device 604 and the battery 606 may be configured for removable coupling to and from the exterior of the protective eyewear 602, such as the first side 612 and/or the second side 614 of the protective eyewear 602, via the attachment bracket 608. Similarly, the image capture device 604 and the battery 606 may also removably couple to the attachment bracket 608, thereby facilitating easy connection and disconnection of the image capture device 604 and the battery 606 with respect to the attachment bracket 608.

By way of example, the first side portion 616 and the second side portion 618 of the attachment bracket 608 may each include a magnetic portion 620. The image capture device 604 and the battery 606 may each include a complementary magnetic portion (e.g., a magnetic surface, a magnetic material, etc.) such that the image capture device 604 and the battery 606 may be magnetically coupled to the first side portion 616 and the second side portion 618 of the attachment bracket 608.

For example, the image capture device 604 may be magnetically (i.e., removably) coupled to the first side portion 616 and the battery 606 may be magnetically (i.e., removably) coupled to the second side portion 618, or vice versa. That is, as illustrated by the direction 680 shown in FIG. 6A, the image capture device 604 and the battery 606 may be interchangeable such that the image capture device 604 and the battery 606 may be configured to removably couple to both the first side portion 616 and the second side portion 618. As such, the image capture device 604 and the battery 606 may be interchangeable such that the image capture device 604 and the battery 606 may be configured to removably couple to the exterior of the protective eyewear 602 at one or more of the same locations, such as the first side 612 and the second side 614 of the protective eyewear 602. Thus, the imaging system 600 may provide additional customization for the user (e.g., the skier).

As shown in FIG. 6A, the battery 606 may be spaced apart from the image capture device 604 when the image capture device 604 and the battery 606 are coupled to the protective eyewear 602 by the attachment bracket 608. For example, the image capture device 604 may be coupled to the first side portion 616 of the attachment bracket 608 (e.g., via the magnetic portion 620 of the first side portion 616) and the battery 606 may be coupled to the second side portion 618 (e.g., via the magnetic portion 620 of the second side portion 618). As a result, the image capture device 604 and the battery 606 may be located on opposing ends of the attachment bracket 608 as measured along a length of the attachment bracket 608 between the first side portion 616 and the second side portion 618, and thus also located on opposing sides of the protective eyewear 602.

As discussed above, the battery 606 may power the image capture device 604 via wiring that may extend through the attachment bracket 608 between the first side portion 616 and the second side portion 618. For example, the wiring may extend between the magnetic portion 620 of the first side portion 616 and the magnetic portion 620 of the second side portion 618. As a result, the image capture device 604 and the battery 606 may be in electrical communication when the image capture device 604 and the battery 606 are coupled to the first side portion 616 and the second side portion 618, respectively, or vice versa.

For example, the magnetic portion 620 of the first side portion 616 and the magnetic portion 620 of the second side portion 618 may each include one or more contacts 622 disposed on, or extending from, the magnetic portion 620 of the first side portion 616 and the magnetic portion 620 of the second side portion 618. The image capture device 604 and the battery 606 may each include complementary electrical leads, such as contacts 624. As a result, the battery 606 and the image capture device 604 may be in electrical communication with one another and/or one or more additional components via the contacts 622 of the attachment bracket 608. Therefore, the image capture device 604 may be powered by the battery 606 even if the battery 606 is spaced apart from the image capture device 604.

The image capture device 604 may be similar to the image capture device 104 shown in FIG. 1A-1B, one or more of the image capture devices 204, 206 shown in FIG. 2A-2B, one or more of the image capture devices 304, 306 shown in FIG. 3, the image capture device 404 shown in FIG. 4A-4B, or an image capture device of the image capture apparatus 500 shown in FIG. 5. The image capture device 604 may include, or may be in communication with, one or more additional components of the imaging system 600. For example, the image capture device 604 may include a lens assembly 626 located at least partially within a body 628 of the image capture device 604 that may be configured to capture images. However, the image capture device 604 is not particularly limited to any one configuration.

The imaging system 600 may also include one or more additional components other than the image capture device 604 and the battery 606. Such components may be separate components that may be interchangeable with the image capture device 604 and/or the battery 606. Alternatively, or additionally, such components may also be integrated into the image capture device 604, the battery 606, the attachment bracket 608, or a combination thereof. By way of example, the imaging system 600 may also include one or more microphones 630, one or more speakers 632, a light 634, or a combination thereof. The microphones 630, the speakers 632, the light 634, or a combination thereof may be integrated into the image capture device 604 and/or the battery 606. For example, as shown in FIG. 6A, the microphones 630, the speakers 632, and the light 634 may be disposed in or coupled to the body 628 of the image capture device 604.

Additionally, by way of example, the image capture device 604 and/or the battery 606 may include one or more buttons and/or controls. For example, the battery 606 may include one or more buttons 642 that are configured to control a volume of audio played by the image capture device 604 (e.g., the speakers 632). The buttons 642 may also be configured to control one or more additional operations of the image capture device 604 or other components of the imaging system 600, such as powering on and off the image capture device 604, capturing an image with the image capture device 604, or the like.

It should be noted that any configuration of the imaging system 600 may be possible with the components as discussed above. For example, the frame 636 of the protective eyewear 602 may include the magnetic portions 620 such that the image capture device 604 and/or the battery 606 may be directly coupled (e.g., removably coupled) to the protective eyewear 602. Alternatively, or additionally, the frame 636 may include one or more recesses or channels that may receive all or a portion of the image capture device 604 and/or the battery 606, thereby providing a lower profile imaging system when coupled to the protective eyewear 602.

Similarly, the imaging system 600 may be used (e.g., connected to) with a variety of protective eyewear 602. For example, the imaging system 600 may be configured to connect with one or more different types of googles, whereby the goggles may vary in size and/or shape. By way of example and as shown in FIG. 6A, the protective eyewear 602 may include a frame 636, a lens 638 secured within the frame 636, and a strap 640 coupled to the frame 636, whereby the strap 640 may secure the protective eyewear 602 to a head of a user (e.g., a skier). In such a case, the attachment bracket 608 may be secured to the frame 636 along the top surface 610, the first side 612, and the second side 614 to secure the imaging system 600 to the protective eyewear 602.

FIG. 6B illustrates another example of the imaging system 600 shown in FIG. 6A. That is, the imaging system 600 shown in FIG. 6B may be the same as the imaging system 600 shown in FIG. 6A unless otherwise stated.

For example, as discussed above, the imaging system 600 may include the attachment bracket 608. The attachment bracket 608 may removably couple to the protective eyewear 602 along a top surface 610, a first side 612, and a second side 614 of the protective eyewear 602. As shown in FIG. 6A, the image capture device 604 may be electrically connected to the battery 606 via wiring extending through the attachment bracket 608. Alternatively, as shown in FIG. 6B, the image capture device 604 may be self-contained such that the image capture device 604 does not require power from the battery 606. In such a case, the image capture device 604 may be removably coupled to the first side portion 616 and/or the second side portion 618 of the attachment bracket 608 without requiring coupling of the battery 606 to the attachment bracket 608. As a result, the attachment bracket 608 may alternatively, or additionally, removably couple other configurations of the imaging system 600 to the protective eyewear 602. For example, when the image capture device 604 includes a self-contained battery, the image capture device 604 may be coupled to the first side portion 616 of the attachment bracket 608 and a secondary microphone, light, speaker, or a combination thereof may be coupled to the second side portion 618 in lieu of the battery 606.

It should be noted that the image capture device 604 of FIG. 6B may be interchanged with the image capture device 604 of FIG. 6A. That is, the image capture device 604 of FIG. 6A may be disconnected from the attachment bracket 608 and replaced with the image capture device 604 of FIG. 6B. As a result, the battery 606 may remain connected to the attachment bracket 608 or the battery 606 may also be disconnected from the attachment bracket 608. Thus, the imaging system 600 may provide additional interchangeability between components.

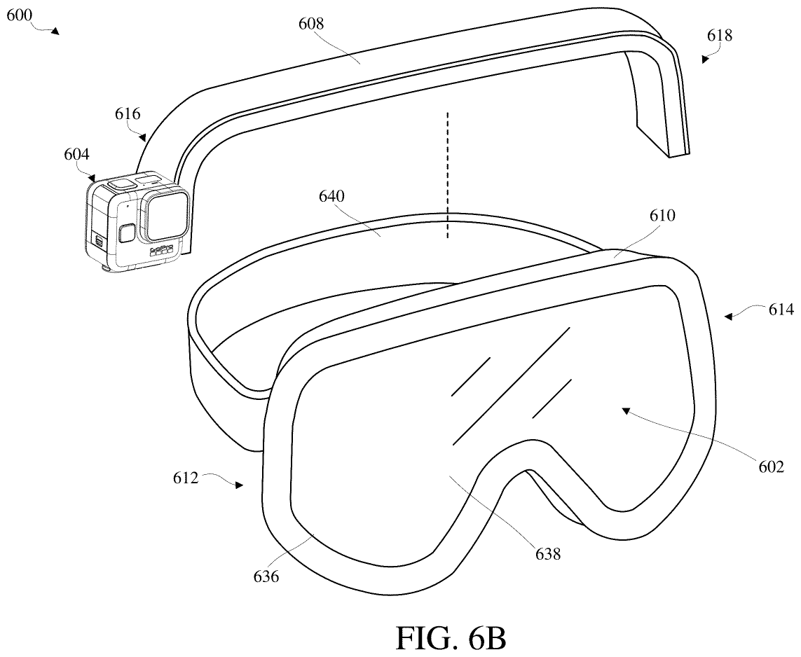

FIGS. 7A-7C illustrate top-down views of examples of an imaging system 700 for protective eyewear 702. The imaging system 700 may be similar to the imaging system 600 of FIGS. 6A and 6B described above. Additionally, the protective eyewear 702 may be similar to the protective eyewear 602 of FIGS. 6A and 6B described above.

As shown in FIG. 7A, the imaging system 700 may include an image capture device 704 and a battery 706 removably coupled to an attachment bracket 708. The image capture device 704 and the battery 706 may be removably coupled to the attachment bracket 708 in any desired manner. For example, the attachment bracket 708 may include one or more magnetic portions similar to the magnetic portion 620 of FIGS. 6A and 6B to magnetically couple the image capture device 704 and the battery 706 to the attachment bracket 708. As a result, the attachment bracket 708 may be removably coupled a top surface 710, a first side 712, and a second side 714 of the protective eyewear 702, thereby positioning the image capture device 704 along the first side 712 of the protective eyewear 702 and the battery 706 along the second side 714 of the protective eyewear 702.

As discussed above, the image capture device may include a lens assembly 726 that is configured to capture images. The lens assembly 726 may be positioned external to the protective eyewear 702 such that the lens assembly 726 may be located outboard of an outermost portion of the protective eyewear 702 to prevent obstruction of the lens assembly 726 by the protective eyewear 702.

By way of example, the protective eyewear 702 may include a frame 736, a lens 738 disposed in the frame 736, and a strap 740 coupled to the frame 736. The strap 740 may secure the protective eyewear 702 to a user such that the user may see out of and through the lens 738. In such a configuration, the lens assembly 726 may be configured to extend outward from the protective eyewear 702 beyond an entirety of an exterior surface of the lens 738. That is, the lens assembly 726 may extend beyond the lens 738 of the protective eyewear 702, as indicated by the dashed line of FIG. 7A that extends between an outermost surface of the lens 738 with respect to the frame 736 and the image capture device 704. As a result, the lens assembly 726 of the image capture device 704 may capture images unobstructed by the protective eyewear 702.

Additionally, as described above, the image capture device 704 may be powered by the battery 706. To do so, the battery 706 may be electrically connected to the image capture device 704 via wiring 742 extending through or along the attachment bracket 708 between the battery 706 and the image capture device 704. That is, the wiring 742 may extend between the first side portion and the second side portion of the attachment bracket 708, and thus may also extend between the first side 712 and the second side 714 of the protective eyewear 702. As a result, the wiring 742 may be integrated into or with the attachment bracket 708 to eliminate additional components that may be difficult for the user to manually position.

FIG. 7B illustrates another example of the imaging system 700. In particular, FIG. 7B illustrates another configuration of the imaging system 700 shown in FIG. 7A.

As shown in FIG. 7A, the image capture device 704 may be removably coupled to the first side 712 of the protective eyewear 702 and the battery 706 may be removably coupled to the second side 714 of the protective eyewear 702. The image capture device 704 and the battery 706 may be interchangeable such that the image capture device 704 and the battery 706 may be positioned in one or more locations with respect to the attachment bracket 708 and the protective eyewear 702.

By way of example, the image capture device 704 and the battery 706 may be swapped with respect to the configuration shown in FIG. 7A. That is, as shown in FIG. 7B, the image capture device 704 may be repositioned along the second side 714 of the protective eyewear 702 and the battery 706 may be repositioned along the first side 712 of the protective eyewear 702. Additionally, even though the image capture device 704 may be relocated to the second side 714, the lens assembly 726 may still maintain a positioned that extends beyond the outermost surface of the lens 738 of the protective eyewear 702, as indicated by the dashed line extending between the image capture device 704 and the lens 738. Moreover, the wiring 742 routed through the attachment bracket 708 may be adapted to electrically connect the image capture device 704 and the battery 706 irrespective of which side (e.g., the first side 712 or the second side 714) the image capture device 704 and the battery 706 are connected to.

FIG. 7C illustrates another example of the imaging system 700. In particular, FIG. 7C illustrates another configuration of the imaging system 700 shown in FIGS. 7A and 7B.

As shown in FIG. 7C, the imaging system 700 may also include one or more additional components other than the image capture device 704 and the battery 706. By way of example, the imaging system 700 may include a secondary image capture device 744 that may be used in conjunction with the image capture device 704. In such a configuration, the secondary image capture device 744 may be positioned on the second side 714 of the protective eyewear while the image capture device 704 may be positioned on the first side 712 of the protective eyewear 702, or vice versa.

As a result, the user may the image capture device 704 and the secondary image capture device 744 to capture images of a greater area around the user when wearing the protective eyewear 702 compared to when utilizing only the image capture device 704. For example, the secondary image capture device 744 may be positioned so that a lens assembly 746 of the secondary image capture device 744 is oriented toward a region behind the user when the user is wearing the protective eyewear 702. As a result, the user may capture images of a region in front of the user via the image capture device 704 and also capture images of the region behind the user via the secondary image capture device 744.

Additionally, it should be noted that the image capture device 704 and the secondary image capture device 744 may be interchangeable with one another (e.g., between the first side 712 and the second side 714) and may also be reoriented in any desired direction with respect to the protective eyewear 702. For example, the image capture device 704 and the secondary image capture device 744 may both be positioned forward and/or rearward with respect to the user when wearing the protective eyewear 702.

Similarly, the image capture device 704 and the secondary image capture device 744 may be in electrical communication with each other via the wiring 742. Alternatively, or additionally, the image capture device 704 and the secondary image capture device 744 may be free of electrical connection with each other, such as when the image capture device 704 and the secondary image capture device 744 each include their own power supply therein (e.g., batteries therein). Similarly, it should be noted that the image capture device 704 and/or the secondary image capture device 744 may also include their own processing components (e.g., a processor, memory, etc.) and/or their own secondary components (e.g., microphone speaker, etc.) As a result, the image capture device 704 and/or the secondary image capture device 744 may be substantially self-contained and may not need a separate battery (e.g., the battery 706) and/or separate secondary components.

Additionally, while FIGS. 7A and 7B illustrate that the components of the imaging system 700 (e.g., the image capture device 704, the battery 706, and the secondary image capture device 744) may be removably coupled to the protective eyewear 702 using the attachment bracket 708, FIG. 7C illustrates that alternatively, or additionally, the components of the imaging system 700 may be removably coupled directly to the protective eyewear 702 without using the attachment bracket 708.

For example, the frame 736 of the protective eyewear 702 may include one or more magnetic portions similar to the magnetic portion 620 of FIGS. 6A and 6B. Such magnetic portions may be located on the first side 712 and the second side 714 of the frame 736 to magnetically couple the image capture device 704, the battery 706, the secondary image capture device 744, or a combination thereof directly to the protective eyewear 702. As a result, the attachment bracket 708 may eliminated to simplify the imaging system 700, lighten the weight for the user wearing the protective eyewear 702, or both.

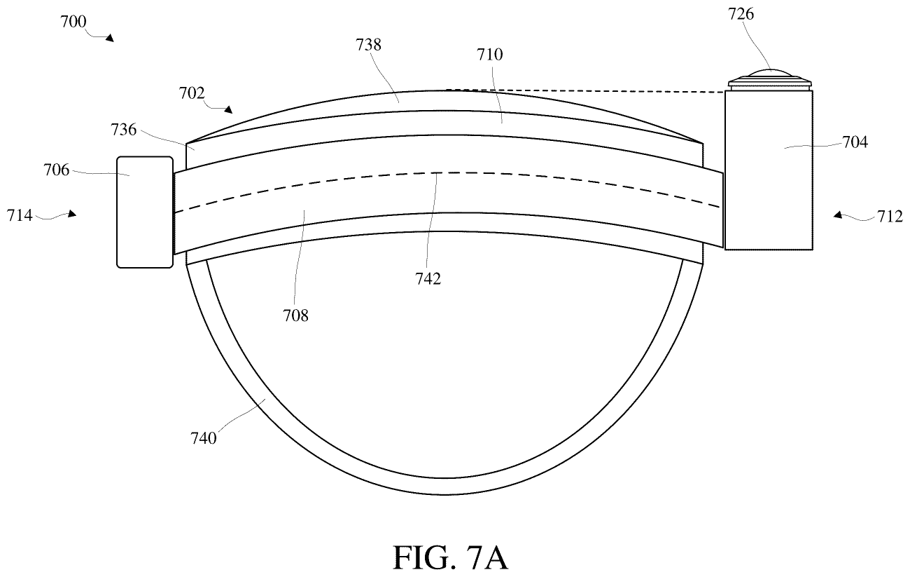

FIG. 8 illustrates a top-down view of an example of a system 800 for protective eyewear 802. The protective eyewear 802 may be similar to the protective eyewear 602 of FIGS. 6A and 6B or the protective eyewear 702 of FIGS. 7A-7C.

As described above, the imaging system 600 of FIGS. 6A and 6B may include the image capture device 604. Similarly, the imaging system 700 of FIGS. 7A-7C may include the image capture device 704 and/or the secondary image capture device 744. Alternatively, the system 800 may be free of an image capture device. That is the system 800 may be an alternative to the imaging system 600 or the imaging system 700. Additionally, the system 800 may also be an alternative configuration of the imaging system 600 or the imaging system 700 when the image capture device(s) of the imaging system 600 or the imaging system 700 are disconnected, present in another location (such as in a hand of a user or coupled to another mount), or otherwise removed.

As shown in FIG. 8, the system 800 may include one or more components, such as a battery 806, removably coupled to the protective eyewear 802, such as along a first side 812 and/or a second side 814 of the protective eyewear 802. For example, the system 800 may include a speaker and microphone assembly 848 removably coupled to the first side 812 of the protective eyewear 802 and a battery 806 removably coupled to the second side 814 of the protective eyewear 802. The battery 806 may power the speaker and microphone assembly 848 via wiring 842 that electrically connects the battery 806 and the speaker and microphone assembly 848. Such connection may be similar to connection described with respect to the wiring 742 of FIGS. 7A-7C.

Based on the configuration of FIG. 8 described above, it should be noted that the battery 806 and the speaker and microphone assembly 848 may be interchangeable to position the battery 806 and the speaker and microphone assembly 848 on either the first side 812 or the second side 814 of the protective eyewear. Additionally, such components may also be interchange with the image capture device 704, the battery 706, and the secondary image capture device 744 of FIGS. 7A-7C, thereby even further increasing the modularity and customization of the imaging system 700 of FIGS. 7A-7C.

While FIG. 8 illustrates that the battery 806 and the speaker and microphone assembly 848 may be directly coupled (e.g., magnetically coupled) to the protective eyewear 802, such as along a frame 836 of the protective eyewear 802, the battery 806 and the speaker and microphone assembly 848 may also be indirectly coupled to the protective eyewear 802. For example, the battery 806 and the speaker and microphone assembly 848 may be coupled to the protective eyewear 802 via the attachment bracket 708 of FIGS. 7A-7B. In such a case, the speaker and microphone assembly 848 may be coupled wirelessly to an additional remote camera or another remote device, such as a smartphone, to provide audio (e.g., phone calls, music etc.). As a result, the speaker and microphone assembly 848 may be easily removed from the protective eyewear 802 and used as a standalone assembly.

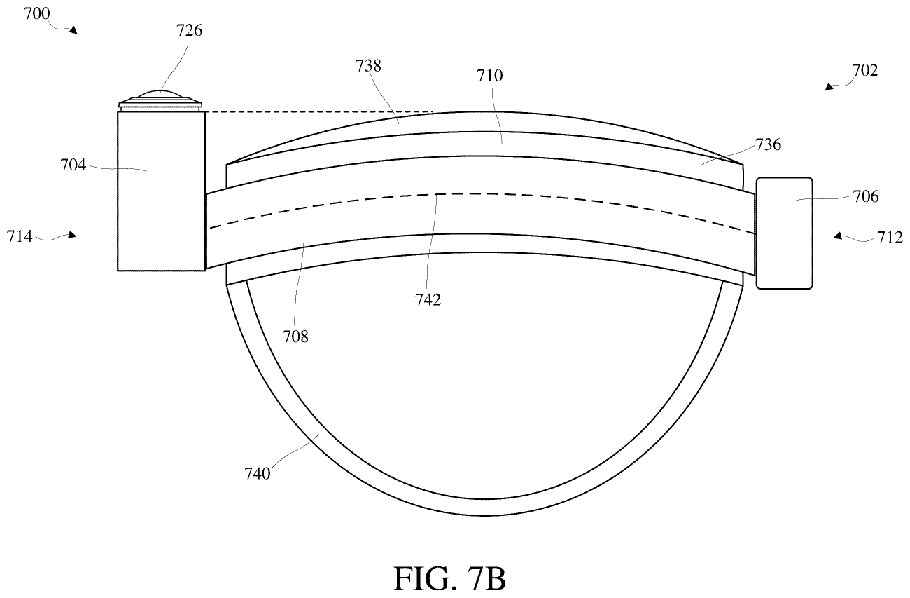

FIG. 9 illustrates a close-up perspective view of an imaging system 900 for protective eyewear 902. The imaging system 900 may be similar to the imaging system 600 of FIGS. 6A and 6B or the imaging system 700 of FIGS. 7A-7C described above. Additionally, the protective eyewear 902 may be similar to the protective eyewear 602 of FIGS. 6A and 6B or the protective eyewear 702 of FIGS. 7A-7C described above.

The imaging system 900 may include one or more components, such as an image capture device similar to those described above, a microphone, a speaker, a light, or a combination thereof. For example, the imaging system 900 may include one or more of the aforementioned components, whereby the components may be powered by a battery 906 of the imaging system 900. The battery 906 and the components of the imaging system 900 may be removably coupled to the protective eyewear 902, such as along an exterior portion of a frame 936 of the protective eyewear 902.

As discussed above, the protective eyewear 902 may be worn by a user (e.g., a skier) such that the imaging system 900 may be operated by the user when worn. The protective eyewear 902 may include the frame 936, a lens 938 disposed in the frame 936, and a strap 940 coupled to the frame 936. The strap 940 may be used to secure the protective eyewear 902 to a head of the user such that the user may look through an interior portion 950 of the protective eyewear 902 to look through the lens 938.

The imaging system 900 may include an indicator light 952 coupled to the protective eyewear 902. The indicator light 952 may be configured to indicate a status of one or more components of the imaging system 900. By way of example, the imaging system may include an image capture device, such as the image capture device 604 of FIGS. 6A and 6B or the image capture device 704 of FIGS. 7A-7C. The indicator light 952 may be configured to indicate a status of the image capture device, such as when the image capture device is powered on and/or in use (e.g., capturing images and/or recording video).

It should be noted that the indicator light 952 may indicate a status of any portion of the imaging system 900. For example, the indicator light 952 may alternatively, or additionally, indicate when the battery 906 is powering one or more components, when the battery 906 is charging, when one or more components other than the image capture device (e.g., speaker, microphone, light, etc.) are in use, or a combination thereof.

The indicator light 952 may be positioned within the interior portion 950 of the protective eyewear 902 such that the indicator light 952 may be viewable by the user when wearing the protective eyewear 902. The indicator light 952 may be integrated into the protective eyewear 902, such as along an interior surface of the frame 936. The indicator light 952 may also be fixed or removably coupled to one or more components of the imaging system 900, such as the battery 906.

For example, the indicator light 952 may be integrated into the battery 906 such that the indicator light 952 may extend through an aperture of the frame 936 to position the indicator light 952 within the interior portion 950 of the protective eyewear 902. It should also be noted that the indicator light 952 may be electrically connected to one or more components of the imaging system 900, such as the battery 906, the image capture device, or both.

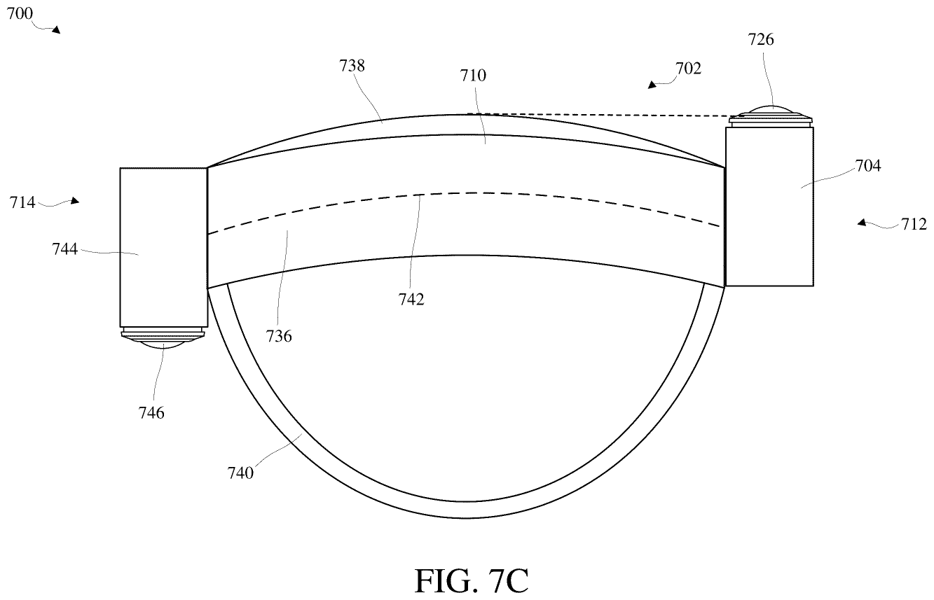

FIGS. 10A and 10B illustrate a front perspective view and a rear perspective view, respectively, of an imaging system 1000 for protective eyewear 1002. The imaging system 1000 may be similar to the imaging system 600 of FIGS. 6A and 6B, the imaging system 700 of FIGS. 7A-7C, or the imaging system 900 of FIG. 9 described above. Additionally, the protective eyewear 1002 may be similar to the protective eyewear 602 of FIGS. 6A and 6B, the protective eyewear 702 of FIGS. 7A-7C, or the protective eyewear 902 described above.

The imaging system 1000 may include an image capture device 1004 and a battery 1006 (FIG. 10B) that may be configured to power the image capture device 1004. The image capture device 1004 may be integrated into or otherwise coupled to the protective eyewear 1002. For example, the image capture device 1004 may be integrated into the protective eyewear 1002 such that the image capture device 1004 may be positioned between a first side 1012 and an opposing second side 1014 of the protective eyewear 1002. As a result, the image capture device 1004 may be positioned such that the image capture device 1004 may capture images free of obstruction from the protective eyewear 1002.

To capture images, the image capture device 1004 may include a lens assembly 1026 disposed in a body 1028 of the image capture device 1004. The lens assembly 1026 may be configured to capture the images when the protective eyewear 1002 is worn by a user. For example, as shown in FIGS. 10A and 10B, the protective eyewear 1002 may include a frame 1036, a lens 1038 disposed in the frame 1036, and a strap 1040 coupled to the frame 1036. The strap 1040 may be secured around a head of the user such that the user may look through the lens 1038 and the image capture device 1004 may be positioned in front of the user adjacent to their forehead. As shown in FIGS. 10A and 10B, the image capture device 1004 may be secured to, or integrated into, the frame 1036 of the protective eyewear 1002.

The imaging system 1000 may also include a power source, such as a battery 1006. The battery 1006 may be removably coupled to the strap 1040 and may be electrically connected (e.g., via wiring extending through the strap 1040, through the frame 1036, or both) to the image capture device 1004 to power the image capture device 1004. Similarly, the imaging system 1000 may also include a user interface 1054, whereby the user may control one or more operations of the image capture device 1004, or other components (e.g., speakers, a light, a microphone, a mobile device, etc.) of the imaging system 1000, via one or more user inputs 1056 (e.g., buttons, capacitive touch sensors, switches, etc.) The user interface 1054 may also be removably coupled to the strap 1040.

As shown in FIGS. 10A and 10B, the image capture device 1004, the battery 1006, the user interface 1054, or a combination thereof may be positioned in various locations along the protective eyewear 1002 with respect to one another. For example, the battery 1006 and the user interface 1054 may be coupled to the strap 1040 via clips or other attachment means that facilitate movement of the battery 1006 and the user interface 1054 along the strap 1040, thereby facilitating easy repositioning of such components by the user for comfort or convenience. Moreover, wiring connecting the battery 1006 and the user interface 1054 with each other and/or with the image capture device 1004 may be routed through or along the strap 1040 and/or the frame 1036 and allow for such movement of components. Alternatively, or additionally, such components may also be wirelessly connected to one another to eliminate some or all of the wiring.

Based on the above, the image capture device 1004 may be integrated into the frame 1036 of the protective eyewear 1002 to ensure high-quality image capturing. Similarly, the battery 1006 and the user interface 1054 may be positioned to space apart the battery 1006 and the user interface 1054 to distribute weight and locate such components in a position as desired by the user. Thus, the user may space apart the user interface 1054, the battery 1006, and the image capture device 1004 from one another while still allowing for operation of the image capture device 1004.

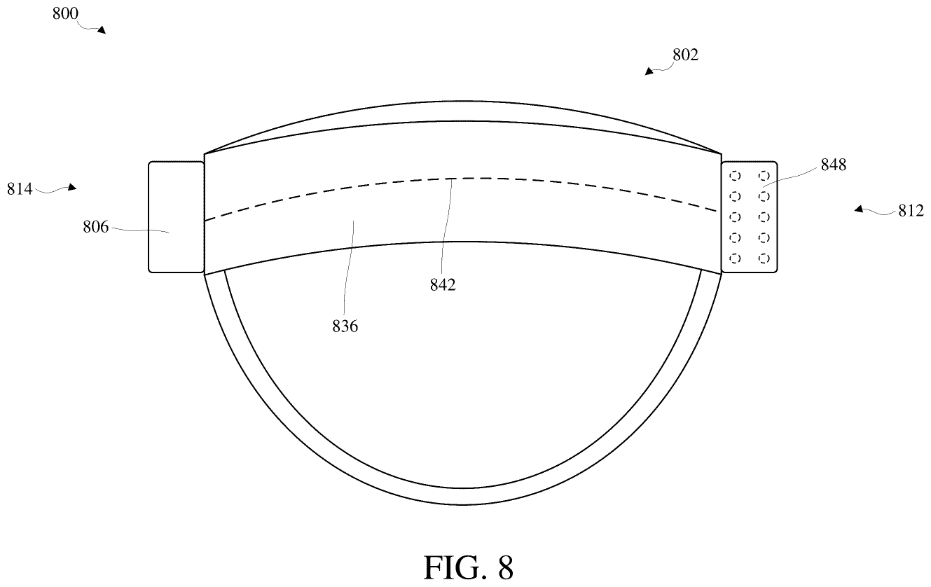

FIG. 11A illustrates a top-down view of an example of an imaging system 1100 for protective eyewear 1102. The protective eyewear may be similar to the protective eyewear 702 shown in FIGS. 7A-7C.

The imaging system 1100 may include an image capture device 1104. The image capture device 1104 may be similar to the image capture device 604 of the imaging system 600 shown in FIGS. 6A and 6B or the image capture device 704 shown in FIGS. 7A-7C. The imaging system 1100 may also include a battery 1106 configured to power the image capture device 1104. The image capture device 1104 and/or the battery 1106 may be configured to removably couple to the protective eyewear 702.

By way of example, the battery 1106 may be removably coupled to and from an exterior of the protective eyewear 1102. For example, the protective eyewear 1102 may include a frame 1110 and a lens 1112 secured within the frame 1110. The frame 1110 may extend around all or a portion of the lens 1112, such as between a first side 1114 and an opposing second side 1116 of the protective eyewear 1102 (e.g., between opposing sides of a user's head when the protective eyewear 1102 is worn by the user). As shown in FIG. 11A, the battery 1106 may be removably coupled to the frame 1110 such that the battery 1106 is positioned on the first side 1114 of the protective eyewear 1102 (e.g., adjacent to a side of the user's head when the protective eyewear 1102 is worn by the user). However, the battery 1106 may also be configured to removably couple to the frame 1110 such that the battery 1106 is positioned on the second side 1116 of the protective eyewear 1102.

The image capture device 1104 may also be removably coupled to protective eyewear 1102 either directly and/or indirectly. For example, the image capture device 1104 may be configured to removably couple to and from an exterior (e.g., an exterior surface) of the battery 1106. As described further below with respect to FIG. 11B, the image capture device 1104 may be coupled to a first side of the battery 1106 while an opposing second side of the battery 1106 may be coupled to the protective eyewear 1102 (e.g., the frame 1110 of the protective eyewear 1102). As such, the battery 1106 may be positioned between the image capture device 1104 and the protective eyewear 1102 such that the image capture device 1104 may be free of direct contact with the protective eyewear 1102. However, in certain configurations, the image capture device 1104 may be in direct contact with a portion of the protective eyewear 1102 (e.g., the frame 1110).

Advantageously, due to the image capture device 1104 being directly coupled to the battery 1106, the protective eyewear 1102 may be free of any wiring. For example, as shown in FIG. 7C, the wiring 742 may extend through a portion of the frame 736 of the protective eyewear 702 between components of the imaging system 700 (e.g., between the image capture device 704 and the additional image capture device 744). Conversely, as shown in FIG. 11A, the frame 1110 may be free of any wiring similar to the wiring 742. That is, the battery 1106 may provide power to the image capture device 1104 free of any wiring. As such, the imaging system 1100 may be adapted for easy interchangeability and/or connectivity to various types of protective eyewear, thereby providing further modularity and customization.

As mentioned above, the protective eyewear 1102 may be worn be the user, such as by using a strap 1118 of the protective eyewear 1102 to secure the protective eyewear 1102 to the user. The image capture device 1104 and the battery 1106 may be coupled to the protective eyewear 1102 such that view of the user through the lens 1112 may remain unobstructed by imaging system 1100. For example, the image capture device 1104 may include a lens assembly 1120 located at least partially within a body of the image capture device 1104 (e.g., a body similar to the body 628 of the image capture device 604 shown in FIG. 6A). The lens assembly 1120 may be positioned adjacent to the lens 1112 of the protective eyewear (e.g., along the first side 1114 of the protective eyewear 1102) such that the lens assembly 1120 may capture images and/or video unobstructed by the protective eyewear 1102 (e.g., as indicated by the dashed line extending from an outermost surface of the lens 1112 of the protective eyewear 1102) while also allowing the user to freely view a surrounding environment through the lens 1112 of the protective eyewear 1102.

The imaging system 1100 may also be coupled to the protective eyewear 1102 in a manner that still facilitates the user interfacing with the imaging system 1100. For example, the image capture device 1104 may include one or more buttons, such as a button 1122, that may receive an input from the user to operate or otherwise control the image capture device 1104. For example, the button 1122 may be a power button to turn on and off the image capture device 1104, a volume control button, another control button, or a combination thereof. It should also be noted that the button 1122 may also be a contact point along the image capture device 1104 (e.g., a capacitive touch device), a display that may receive a user input (e.g., a touchscreen), or any other type of interface that may receive a user input.

FIG. 11B is a perspective view of the imaging system 1100 shown in FIG. 11A. The protective eyewear 1102 have been removed for illustrative purposes to better illustrate connectivity between the image capture device 1104 and the battery 1106.

As described above, the image capture device 1104 may removably couple to the battery 1106, whereby the battery 1106 may be removably coupled to the protective eyewear 1102 to connect the imaging system 1100 to the protective eyewear 1102. As shown in FIG. 11B, the image capture device 1104 may magnetically couple to the battery 1106 such that the battery 1106 may be positioned between the image capture device 1104 and the frame 1110 of the protective eyewear 1102 (e.g., such that the image capture device 1104 is free of direct contact with the protective eyewear 1102). For example, the battery may include a first magnetic portion 1124 to magnetically couple the battery 1106 to the frame 1110 of the protective eyewear 1102 and a second magnetic portion 1126 to couple the image capture device 1104 to the battery 1106. The first magnetic portion 1124 and the second magnetic portion 1126 may be located anywhere along the battery 1106, such as on a first side and an opposing second side, respectively, of the battery 1106.

It should be noted that any coupling means may be used to secure the battery 1106 to the image capture device 1104 and to secure the battery 1106 to the protective eyewear 1102. For example, the battery 1106 and the image capture device 1104 and/or the battery 1106 and the protective eyewear 1102 may be removably coupled to one another using any mechanical interlock, fasteners, adhesives, or a combination thereof.

Coupling of the image capture device 1104 to the battery 1106 may also facilitate powering the image capture device 1104 by the battery 1106. For example, the battery 1106 may include one or more electrical contacts, such as the electrical contacts 1146. The electrical contacts 1146 may contact a portion of the image capture device 1104 (e.g., respective electrical contacts of the image capture device 1104) to power the image capture device 1104 through the electrical contacts 1146 of the battery 1106. Thus, the battery 1106 may power the image capture device 1104 free of wiring extending therebetween.

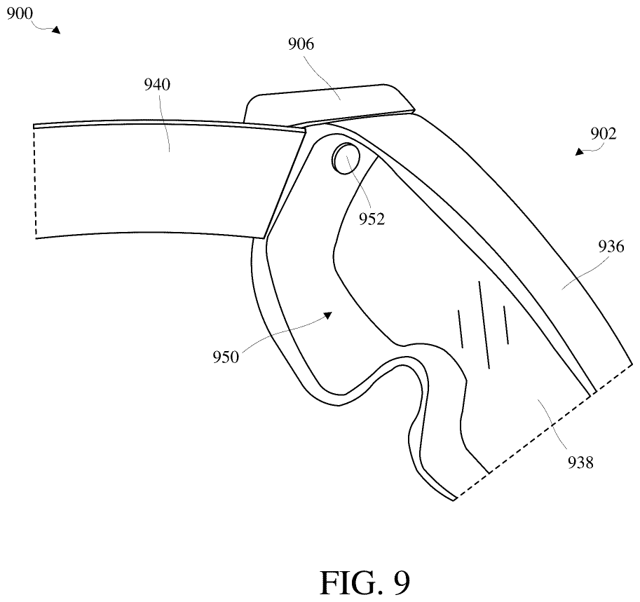

FIG. 12 illustrates a perspective view of another example of an imaging system 1200 for protective eyewear 1202. The protective eyewear may be similar to the protective eyewear 1002 shown in FIGS. 10A and 10B. The imaging system 1200 may be similar to the imaging system 1000 shown in FIGS. 10A and 10B.

The imaging system 1200 may include an image capture device 1204 and a battery 1206 that may be configured to power the image capture device 1204. The image capture device 1204 may be integrated into or otherwise coupled to the protective eyewear 1202. For example, the image capture device 1204 may include a body 1208 that is integrated into a frame 1210 of the protective eyewear 1202 such that a lens assembly 1212 of the image capture device 1204 may be at least partially disposed in the body 1208. The lens assembly 1212 may be disposed in the body 1208 of the image capture device 1204 so that a field of view of the image capture device 1204 may extend forward (e.g., in front of) the protective eyewear 1202 between a first side 1213 and an opposing second side 1214 of the protective eyewear 1202. As a result, the image capture device 1204 may be positioned such that the image capture device 1204 may capture images and/or video free of obstruction from the protective eyewear 1202.

The image capture device 1204 (e.g., the lens assembly 1212) may be configured to capture the images and/or video when the protective eyewear 1202 is worn by a user. For example, the protective eyewear 1202 may include a lens 1216 disposed in the frame 1210 and a strap 1218 coupled to the frame 1210. The strap 1218 may be secured around a head of the user such that the user may look through the lens 1216 and the image capture device 1204 may be positioned in front of the user adjacent to their forehead.

The imaging system 1200 may also include a power source, such as the battery 1206. The battery 1206 may be removably coupled to the strap 1218 and may be electrically connected (e.g., via wiring 1220 extending through the strap 1218, through the frame 1210, or both) to the image capture device 1204 to power the image capture device 1204. The imaging system 1200 may also include a user interface 1222, whereby the user may control one or more operations of the image capture device 1004 or other components (e.g., speakers, a light, a microphone, a mobile device, etc.) of the imaging system 1200 using one or more user inputs, such as a button 1224 and/or a display 1226. The user inputs may be any configuration (e.g., buttons, capacitive touch sensors, switches, etc.) that may facilitate control of the imaging system 1200 by the user. For example, the button 1224 and/or the display 1226 may be part of, or otherwise coupled to, the battery 1206.

The user inputs may also be part of, or otherwise coupled to, a computing device 1228 of the imaging system 1200. The computing device 1228 may be similar to the image capture apparatus 500 shown in FIG. 5 or may include one or more components similar to the components of the image capture apparatus 500 (e.g., processing components similar to the processing components 520, storage similar to the storage 536, etc.) The computing device 1228 may be configured to control operation of the image capture device 1204 (e.g., control capturing of images and/or video) and/or may be configured to control operation of other components of the imaging system 1200, etc.) For example, the computing device 1228 may control operation of the image capture device 1204 based on user input (e.g., input via the user interface 1222).

The computing device 1228 may be removably coupling to and from the protective eyewear 1202. The computing device 1228 may be removably coupled to any portion of the protective eyewear 1202. For example, the computing device 1228 may be coupled to the strap 1218 such that the computing device 1228 is spaces apart from both the image capture device 1204 and the battery 1206. The computing device 1228 may be in electrical communication with the battery 1206 and/or the image capture device 1204 via the wiring 1220 (illustrates as dashed lines between the computing device 1228 and the image capture device 1204).

To further integrate the imaging system 1200 with the protective eyewear 1202, the computing device 1228 and/or the battery 1206 may be integrated into or coupled to one or more buckles of the protective eyewear 1202, such as the buckle 1230. The buckle 1230 may be configured to adjust a length of the strap 1218 to loosen or tighten the protective eyewear 1202 to properly secure the protective eyewear 1202 to the user. As shown in FIG. 12, the computing device 1228 may be formed with the buckle 1230 such that the buckle 1230 may still operate to adjust the length of the strap 1218 without interference from the computing device 1228. Thus, imaging system 1200 may not require additional components coupling to portions of the protective eyewear 1202 (e.g., the strap 1218).

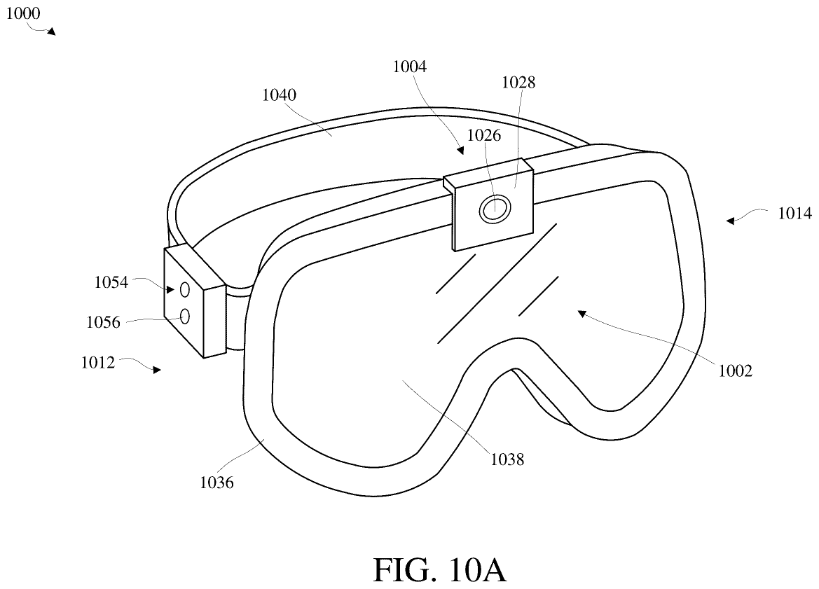

FIG. 13A illustrates cross-section 13A-13A of the imaging system 1200 shown in FIG. 12. As described above, the wiring 1220, which may connect the image capture device 1204 to the computing device 1228 and/or the battery 1206, may be routed through the strap 1218 of the protective eyewear 1202. As shown in FIG. 13A, the strap 1218 may define a channel 1332 and the wiring 1220 may be routed (e.g., extend through) at least a portion of the channel 1332. The channel 1332 may be any size and/or shape that may facilitate routing of the wiring 1220 therein between the components of the imaging system 1200. For example, the channel 1332 may be complementary in shape to a shape of the wiring 1220. Additionally, it should be noted that the wiring 1220 may be any configuration and may include any number of wires, conduits, or other components.

FIG. 13B illustrates another example of a cross-section of the imaging system 1200 shown in FIG. 12. The cross-section illustrates a section of the strap 1218, which may be similar to the cross-section shown in FIG. 13A. As described above, the strap 1218 may define a channel 1332 therein and the wiring 1220 may be routed through the channel 1332. As shown in FIG. 13A, the strap 1218 may be substantially closed to encircle an entirety of the channel 1332. Conversely, in certain configurations and/or along certain portions of the strap 1218, the strap 1218 may be open ended yet may still define the channel 1332. For example, as shown in FIG. 13B, the strap 1218 may be folded onto itself to form the channel 1332 and stitching 1334 may be used to secure the strap 1218 to itself to close the channel 1332 and protect the wiring 1220 from moisture and/or debris. However, and connection means may be used to close the channel 1332, such as using an adhesive or other means of mechanically fastening the strap 1218 to itself. Thus, the wiring 1220 may be concealed from the user from a viewpoint external to the protective eyewear 1202.

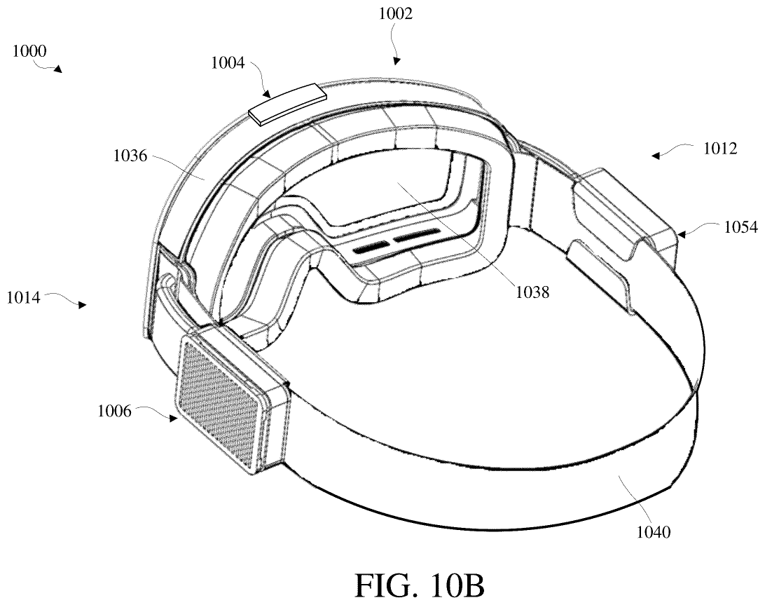

FIG. 14 is a close-up, perspective view of the imaging system 1200 shown in FIG. 12. As discussed above, the computing device 1228 may be electrically connected to the image capture device 1204 via the wiring 1220. The wiring 1220 may be routed through at least a portion of the strap 1218 between the image capture device 1204 and the computing device 1228.

The computing device 1228 may be coupled to or integrally formed with the buckle 1230 of the protective eyewear 1202 such that, when the buckle 1230 is moved along the strap 1218 to adjust the length of the strap 1218, the computing device 1228 may also move freely with the buckle 1230. Additionally, the wiring 1220 may be routed through the strap 1218 such that a length of the wiring 1220 may be changed based upon movement of the buckle 1230, such as in the direction (D). That is, as the buckle 1230 moves along the strap 1218 to adjust the length of the strap 1218, the wiring 1220 may extend and/or contract to accommodate the movement of the buckle 1230 while still remaining coupled to both the computing device 1228 and the image capture device 1204. Thus, the wiring 1220 may be flexible to bend or otherwise flex without damaging the wiring 1220.

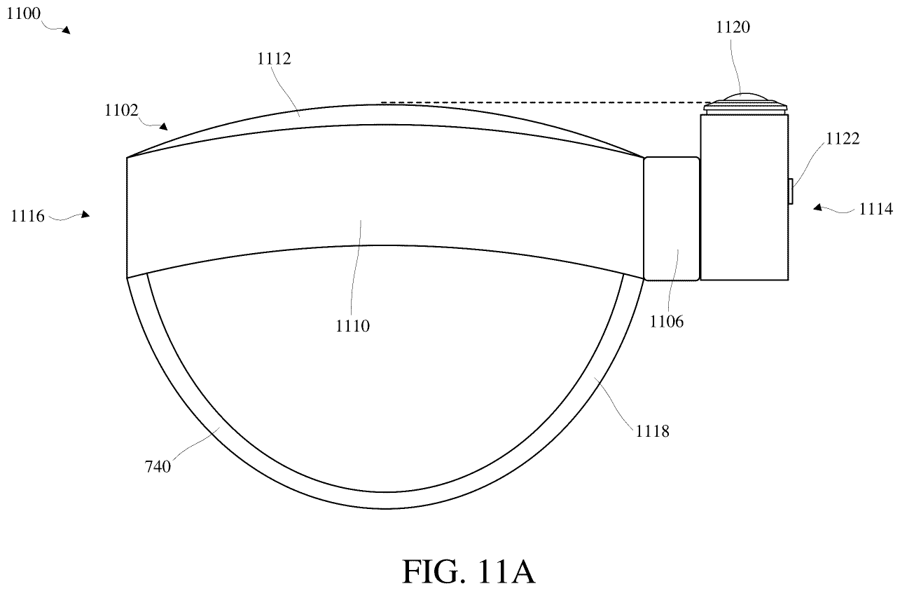

FIG. 15A illustrates a perspective view of an imaging system 1500 prior to coupling to protective eyewear 1502. FIG. 15B illustrates another perspective view of the imaging system 1500 after coupling to the protective eyewear 1502. The imaging system 1500 may be configured for removably coupling to and from an exterior of the protective eyewear 1502. By way of example, the imaging system 1500 may be configured to removably couple to any type of protective eyewear, such as ski or snowboard goggles, motorcycling goggles, motocross goggles, sunglasses, skydiving goggles, other types of protective eyewear, or a combination thereof. As such, the imaging system 1500 may not be limited to use with or as part of any particular type of protective eyewear. For illustrative purposes, the protective eyewear 1502 shown in FIG. 15A is a pair of goggles configured to be worn by a skier or snowboarder.

The imaging system 1500 may include an image capture device 1504 and a control module 1506 configured to power and/or operate the image capture device 1504. As discussed further below, the image capture device 1504 and the control module 1506 may be removably coupled to the protective eyewear 1502. That is, the image capture device 1504 and the control module 1506 may be removably coupled to the protective eyewear 1502 such that the imaging system 1500 (e.g., the image capture device 1504) may be operated when coupled to the protective eyewear 1502 and the protective eyewear 1502 is worn by a user. For example, as shown in FIG. 15A, the imaging system 1500 may be configured to removably couple to a receiving portion 1508 disposed along a frame 1510 of the protective eyewear 1502.

The image capture device 1504 and the control module 1506 may be configured for removable coupling to and from the exterior of the protective eyewear 1502, such as a first side 1512 and/or a second side 1514 of the protective eyewear 1502, via the receiving portion 1508 disposed on the first side 1512 of the protective eyewear 1502 and/or a secondary receiving portion disposed on the second side 1514 of the protective eyewear 1502. For example, as shown in FIG. 15B, the image capture device 1504 may be removably coupled to the receiving portion 1508 such that the image capture device 1504 may be secured to the frame 1510. To facilitate such connection, a cover 1516 may be removed from the receiving portion 1508 to expose an opening of the receiving portion 1508 defined by the frame 1510 of the protective eyewear 1502. That is, when the imaging system 1500 (e.g., the image capture device 1504) is not coupled to the protective eyewear 1502, the cover 1516 may remain coupled to or otherwise covering the receiving portion 1508 to protect the receiving portion 1508 from moisture and/or debris. Therefore, the receiving portion 1508 and the cover 1516 may facilitate easy connection and disconnection of the image capture device 1504 to the frame 1510.

The image capture device 1504 may be removably coupled to the receiving portion 1508 in any desired manner. For example, the image capture device 1504 may be releasably coupled to the receiving portion 1508 via a mechanical engagement between the image capture device 1504 and the receiving portion 1508. The mechanical engagement may be facilitated by a mechanical interlock (e.g., a keying feature, hook-and-loop fastener, dovetail joint, press-fit engagement, threaded engagement, other fastening technique, etc.), a magnetic coupling (e.g., the image capture device 1504 or a portion thereof that is received by the receiving portion 1508 may magnetically engage the receiving portion 1508 or a portion thereof, such as a magnet disposed in the receiving portion 1508), or both.

The removable coupling of the image capture device 1504 to the receiving portion 1508 may also facilitate adjustment of the image capture device 1504 with respect to the frame 1510 of the protective eyewear 1502. By way of example, the image capture device 1504 may be configured to rotate, such as in a direction 1542 (FIG. 15B), with respect to the frame 1510 to adjust a field of view of the image capture device 1504. Such rotation may be possible even when the image capture device 1504 is removably coupled to the receiving portion 1508. That is, the image capture device 1504 may be rotated in the direction 1542 while maintaining connection between the image capture device 1504 and the frame 1510 (e.g., between the image capture device 1504 and the receiving portion 1508 defined by the frame 1510). Such rotation of the image capture device 1504 may be facilitated by the mechanical and/or magnetic coupling between the image capture device 1504 and the receiving portion 1508.

As shown in FIG. 15A, the control module 1506 may be spaced apart from the image capture device 1504 and connected to the image capture device 1504 by wiring 1518 extending therebetween. The wiring 1518 may be fixedly connected (e.g., hardwired) or removably connected to the image capture device 1504 and/or the control module 1506. The wiring 1518 may facilitate powering of the image capture device 1504 by the control module 1506. The wiring 1518 may also facilitate control (e.g., operation) of the image capture device 1504 by the control module 1506. For example, the control module 1506 may include a user input 1520 (e.g., a button, toggle, switch, capacitive touch sensor, or other control) that is configured to receive an input from the user to operate the image capture device 1504 (e.g., to initiate and/or stop capturing of images). Such a connection may allow the user to operate the image capture device 1504 via the control module 1506 even when the imaging system 1500 is coupled to the protective eyewear 1502.

The image capture device 1504 may be similar to the image capture device 104 shown in FIG. 1A-1B, one or more of the image capture devices 204, 206 shown in FIG. 2A-2B, one or more of the image capture devices 304, 306 shown in FIG. 3, the image capture device 404 shown in FIG. 4A-4B, or an image capture device of the image capture apparatus 500 shown in FIG. 5. The image capture device 1504 may include, or may be in communication with, one or more additional components of the imaging system 1500. For example, the image capture device 1504 may include a lens assembly located at least partially within a body of the image capture device that may be configured to capture images. However, the image capture device 1504 is not particularly limited to any one configuration.

All or a portion of the imaging system 1500 may be coupled to the frame 1510 of the protective eyewear 1502, a lens 1522 secured to the frame 1510, a strap 1524 of the protective eyewear 1502 configured to secure the protective eyewear 1502 to a head of the user, or a combination thereof. For example, as shown in FIG. 15B, the imaging system 1500 may be coupled to both the frame 1510 and the strap 1524. In particular, the image capture device 1504 may be removably (e.g., magnetically, press-fit connection, other mechanical connection, etc.) connected to the receiving portion 1508 of the frame 1510 and the control module 1506 may be removably (e.g., magnetically, mechanically, etc.) coupled to the strap 1524. The strap may define one or more apertures positioned along the first side 1512 of the protective eyewear 1502, such as the apertures 1526. The apertures 1526 may define openings to permit access to an interior channel 1528 of the strap 1524 such that the wiring 1518 of the imaging system 1500 may be routed through the interior channel 1528 to contain the wiring 1518 within the strap 1524 when the imaging system 1500 is coupled to the protective eyewear 1502.

Additionally, to facilitate coupling of the imaging system 1500 to the first side 1512 and/or the second side 1514, the strap 1524 may also define one or more apertures positioned along the second side 1514 of the protective eyewear 1502, such as the apertures 1530. Similar to the apertures 1526 along the first side 1512 of the protective eyewear 1502, the apertures 1530 may define openings to permit access to an interior channel (e.g., the interior channel 1528 or another interior channel located along the second side 1514 of the protective eyewear 1502 and connected to, or separate from, the interior channel 1528) of the strap 1524 such that the wiring 1518 of the imaging system 1500 may be routed through the interior channel to contain the wiring 1518 within the strap 1524 when the imaging system 1500 is coupled to the second side 1514 of the protective eyewear 1502. Thus, the strap 1524 may allow for the imaging system 1500 to removably couple to the first side 1512 and the second side 1514 of the protective eyewear 1502 and may allow for easy connection and disconnection from both the first side 1512 and the second side 1514. The strap 1524 may also allow for the wiring 1518 to be routed through an interior (e.g., through the interior channel 1528) of the strap 1524 to avoid externally exposing substantially all or a portion of the wiring 1518.

FIG. 15C illustrates a top-down view of the imaging system 1500 and the protective eyewear 1502 of FIGS. 15A and 15B to better illustrate the modularity and functionality of the imaging system 1500. As shown in FIG. 15C, the imaging system 1500 may be removably coupled to the first side 1512 of the protective eyewear. In particular, the image capture device 1504 may include a connecting portion 1532, such as a magnetic projection, press-fit feature, or other mechanical portion, that may engage the receiving portion and couple the image capture device 1504 to the frame 1510. For example, the connecting portion 1532 may be a magnetic projection extending from the image capture device 1504 that may be received by the receiving portion 1508 to magnetically and/or mechanically engage the image capture device 1504 to the frame 1510.

The connecting portion 1532 may also be coupled to the receiving portion 1508 to facilitate rotation of the image capture device 1504 in the direction 1542, as shown in FIG. 15B. For example, the connecting portion 1532 may include teeth 1533 or other projections that may mesh with complementary teeth 1535 disposed in the receiving portion 1508 to provide incremental rotation of the image capture device 1504 with respect to the frame 1510. That is, the teeth 1533 of the connecting portion 1532 may act as a gear that meshes with the teeth 1535 or other projections disposed in the receiving portion 1508. As a result, the meshing teeth between the connecting portion 1532 and the frame 1510 may allow for incremental, geared rotation of the image capture device 1504 in the direction 1542, while also maintaining any desired position of the image capture device 1504 (i.e., due to engagement between the teeth 1533 of the connecting portion 1532 and the teeth 1535 of the receiving portion 1508). Thus, the receiving portion 1508 may define an axis of rotation of the image capture device 1504.

The image capture device 1504 may be coupled to the frame 1510 and/or the strap 1524 in any desired manner. For example, in certain implementations, both the image capture device 1504 and the control module 1506 may be coupled to the strap 1524. By way of example, the receiving portion 1508 may be disposed along the strap 1524 instead of the frame 1510 such that the image capture device 1504 may be releasably coupled to the strap 1524 instead of the frame 1510. As a result, the strap 1524 may provide modularity to any version of the frame 1510 or any type of protective eyewear, which may be similar to, or different from, the protective eyewear 1502. That is, the strap 1524 may be interchangeable with various types of protective eyewear such that the image capture device 1504, including the control module 1506, may be coupled to any desired protective eyewear that is configured to connect to the strap 1524.

The imaging system 1500 may also include one or more additional components other than the image capture device 1504 and the control module 1506. Such components may be separate components that may be interchangeable with the image capture device 1504 and/or the control module 1506. Alternatively, or additionally, such components may be integrated into the image capture device 1504, the control module 1506, the protective eyewear 1502, or a combination thereof. By way of example, the imaging system 1500 may also include a secondary attachment 1534, such as a microphone, a speaker, a communication system (e.g., a radio communication system), or a combination thereof.

The secondary attachment 1534 may also be removably coupled to the protective eyewear 1502 in a similar or different manner compared to the image capture device 1504 and/or the control module 1506. For example, as shown in FIG. 15C, the secondary attachment 1534 may also include a connecting portion 1536, which may be similar or different from the connecting portion 1532 of the image capture device 1504. As such, the connecting portion 1536 may be received by a secondary receiving portion 1538 defined by the frame 1510 of the protective eyewear 1502 such that the secondary attachment 1534 may be removably coupled to the protective eyewear 1502 along the second side 1514 of the protective eyewear 1502. That is, the image capture device 1504 may be positioned on the first side 1512 of the protective eyewear 1502 while the secondary attachment 1534 may be positioned on the second side 1514 of the protective eyewear 1502, thus preventing any obstruction of the user's view through the lens 1522 when the protective eyewear 1502 is worn by the user.

To facilitate removable connection of the control module 1506 to the strap 1524, the control module 1506 may include an engagement portion 1540. The engagement portion 1540 may be a clip, one or more channels, or other engaging features of the control module 1506 that may connect the control module 1506 to the strap 1524. The engagement portion 1540 may also allow for adjustment of the control module 1506 along the strap 1524. For example, the engagement portion 1540 may allow the control module 1506 to slide along the strap 1524 towards the first side 1512 and/or the second side 1514 based upon user preference with respect to a position of the control module 1506 when the protective eyewear 1502 is worn by the user. Thus, the engagement portion 1540 may provide even further adjustability of the imaging system 1500 when coupled to the protective eyewear 1502.

The control module 1506 may also be further customizable to facilitate additional functionality of the control module 1506 and/or the image capture device 1504. For example, the control module 1506 may be configured to directly and/or indirectly communicate with one or more accessories, such as an accessory 1544. Upon connecting the accessory 1544 to the control module 1506, the accessory 1544 may facilitate additional or alternative functionality of the control module 1506 and/or the image capture device 1504. By way of example, the accessory 1544 may be mechanically and/or electrically coupled to the control module 1506 so that the accessory 1544 may communicate with the control module 1506 directly and/or with the image capture device 1504 indirectly (e.g., indirectly through the control module 1506 and the wiring 1518). Mechanical and/or electrical coupling of the accessory 1544 to the control module 1506 is not particularly limited to any type of connection. For example, the accessory 1544 may be coupled to the control module 1506 in a similar manner to coupling the image capture device 1504 to the frame 1510 (e.g., via the receiving portion 1508 of the frame 1510 receiving the connecting portion 1532 of the image capture device 1504).

Additionally, or alternatively, the control module 1506 may include one or more electrical contacts 1546 (e.g., pins, contact surfaces, receiving portions, etc.) that are configured to contact one or more electrical contacts, such as the electrical contacts 1548 (e.g., pins, contact surfaces, receiving portions, etc.) of the accessory 1544 to establish electrical communication therebetween. Contact between the electrical contacts 1546 of the control module 1506 and the electrical contacts 1548 of the accessory 1544 may also mechanically couple the accessory 1544 to the control module 1506. For example, the electrical contacts 1546 of the control module 1506 may be magnetically coupled to the electrical contacts 1548 of the accessory 1544 to physically couple (e.g., releasably couple) the accessory 1544 to the control module 1506, thereby providing a quick-release connection to allow a user to easily connect and disconnect the accessory 1544 from the control module 1506.

The accessory 1544 may be any type of accessory that supplements operation of the imaging system 1500, such as a microphone, speaker, light, display, or other type of module. For example, the accessory 1544 may be a power module (e.g., a battery or power cell) that may provide additional power capacity for the image capture device 1504 and/or the control module 1506. The accessory 1544 may be a solar panel that may recharge a power module of the control module 1506 and/or the image capture device 1504. The accessory 1544 may also be an additional component that furthers operation of the control module 1506 and/or the image capture device 1504. For example, the accessory 1544 may facilitate wireless communication between the control module 1506 and/or the image capture device 1504 and one or more additional devices. By way of example, the accessory 1544 may be a cellular module (e.g., a 4G module and/or a 5G module) that may enable the control module 1506 and/or the image capture device 1504 to connect to a cellular network, thereby facilitating cellular communication between the control module 1506 and/or the image capture device 1504 and other external devices (e.g., mobile phones, laptops, tablets. cloud-based servers, etc.).

The accessory 1544 may alternatively, or additionally, be configured to establish peer-to-peer (P2P) communication in a manner other than over a cellular network. For example, the accessory 1544 may be or may include a transmitter and/or a receiver that establishes audio and/or video communication between the control module 1506 and/or the image capture device 1504 and one or more external devices. The accessory 1544 may also establish radio frequency (RF) communication between the control module 1506 and/or the image capture device 1504 and one or more external devices. By way of example, the accessory 1544 may establish RF communication (e.g., audio transmission) between a user wearing the imaging system 1500 and an additional individual wearing an additional imaging system, which may be similar to or different from the imaging system 1500. As such, the accessory 1544 may create a communication network of users operating similar imaging systems.

It should be noted that such communications may be possible during operation of the imaging system 1500. For example, a user may record images or video via the image capture device 1504 while simultaneously communicating with other individuals. Moreover, such images or video recordings may be automatically transmitted, via the accessory 1544, to a cloud-based server for storage. Moreover, the accessory 1544 may be configured for communication with the secondary attachment 1534. For example, the secondary attachment 1534 may be a light, and the accessory 1544 may establish wireless communication between the control module 1506 and the light so that the user may wirelessly turn on and off the light via the control module 1506. Thus, the secondary attachment 1534 may no longer require a user interface, thereby facilitating a smaller footprint of the secondary attachment 1534.

The imaging system 1500 may be used (e.g., connected to) with a variety of protective eyewear 1502. For example, the imaging system 1500 may be configured to connect with one or more different types of googles, whereby the goggles may vary in size and/or shape. By way of example and as shown in FIG. 15A, the protective eyewear 1502 may be googles configured to be worn by the user during skiing and/or snowboarding. However, the protective eyewear 1502 may also be motorcross goggles, safety goggles, prescription glasses, sunglasses, or other types or protective eyewear 1502. Thus, the imaging system 1500 may be interchangeable with various types of the protective eyewear 1502 to provide additional customization and interconnectivity.

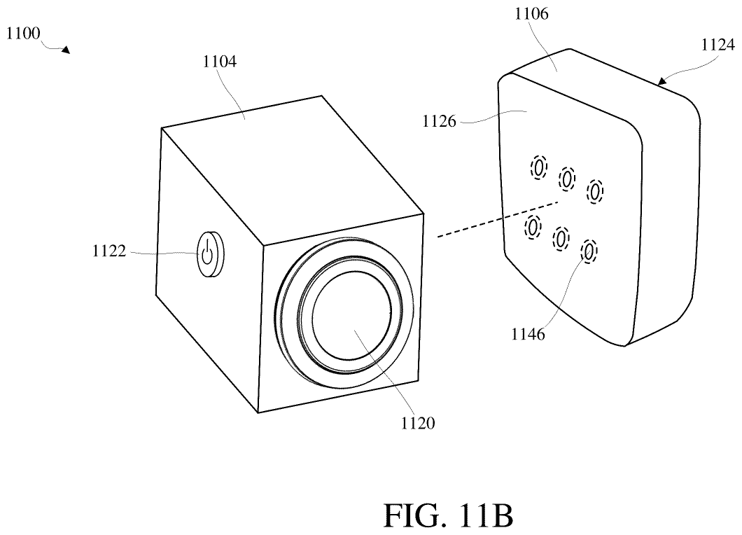

FIG. 16A illustrates a top-down view of an example of an imaging system 1600 for protective eyewear. FIGS. 16B, 16C, and 16D illustrate a side view, a rear view, and a front view, respectively of the imaging system 1600 shown in FIG. 16A. The imaging system 1600 may be similar to the imaging system 1500 of FIGS. 15A-15C described above. Additionally, the imaging system 1600 may be configured to couple to any protective eyewear, such as the protective eyewear 1502 of FIGS. 15A-15C described above.

As shown in FIG. 16A, the imaging system 1600 may include an image capture device 1604 and a control module 1606. The image capture device 1604 and the control module 1606 may be removably coupled to the protective eyewear in any desired manner. For example, the image capture device 1604 may include a connecting portion 1632 projecting from a body 1650 of the image capture device 1604. The connecting portion 1632 may be similar to the connecting portion 1532 of the image capture device 1504 of FIGS. 6A-15C. For example, the connecting portion 1632 may be magnetic to magnetically couple the image capture device 1604 to the protective eyewear (e.g., to a receiving portion of a frame of the protective eyewear).

The image capture device 1604 may also include a lens assembly 1652 that is configured to capture images. The lens assembly 1652 may be positioned external to the protective eyewear such that the lens assembly 1652 may be located outboard of an outermost portion of the protective eyewear to prevent obstruction of the lens assembly 1652 by the protective eyewear. For example, as shown in FIG. 16D, the lens assembly 1652 may be at least partially contained within the body 1650 of the image capture device 1604. The lens assembly may facilitate image capturing using an image sensor disposed within the body 1650 of the image capture device 1604 that is in communication with the control module 1606 via wiring 1618 of the imaging system 1600 connecting the control module 1606 to the image capture device 1604. For example, the control module may include a user input 1620, a button 1654, or both. The user may control operation of the image capture device 1604 via the user input 1620 and/or the button 1654. For example, the user may power on and off the image capture device 1604 via the button 1654 and may toggle image capturing by the image capture device 1604 by pressing the user input 1620. The control module 1606 may also include a light 1656 to indicate a status (e.g., powered on, powered off, charging, activated, etc.) of the imaging system 1600 to further improve the user interface with the imaging system 1600. Additionally, the image capture device 1604 may include a light 1657 that may be similar to the light 1656 and may indicate a status (e.g., powered on, powered off, charging, activated, etc.) of the image capture device 1604.

Additionally, the control module 1606 may power the image capture device 1604 via the wiring 1618. For example, the control module 1606 may include a battery contained within a body 1658 of the control module 1606, whereby the battery may be in electrical communication with the image capture device 1604 via the wiring 1618. The battery may thus facilitate operation of the image capture device 1604 without requiring an external power source. However, in some configurations, the control module 1606 may allow for additional connectivity to additional power sources, such as an external wall outlet or secondary battery pack. For example, the control module 1606 may include contacts 1660 that may electrically connect with the external or secondary power source (e.g., the secondary battery pack). As such, the control module 1606 may provide additional power to extend the operating time of the image capture device 1604. Similarly, the contacts 1660 may also facilitate charging of the battery contained within the body 1658 of the control module 1606. Due to temperatures of the control module 1606 potentially increasing due to charging and/or powering of the image capture device 1604, the body 1658 of the control module 1606 may also include a ridged surface 1662. The ridged surface 1662 may improve airflow through and/or around the control module 1606. The ridged surface 1662 may also include one or more ribs, fins, or other projections that may act as a heat sink for the control module 1606 to dissipate internal heat generated by the control module 1606 (e.g., heat generated by the battery of the control module 1606). Thus, an operating temperature of the control module 1606 may be maintained without overheating the imaging system 1600.

Moreover, to further improve robustness of the imaging system 1600, the image capture device 1604 (e.g., the body 1650 of the image capture device 1604) may include one or more fins 1664 along an exterior surface. The one or more fins 1664 may act as an additional heat sink and/or may improve the structural integrity of the image capture device 1604. For example, the fins 1664 may improve the structural integrity of the body 1650 of the image capture device 1604 to prevent damage to the body 1650 of the image capture device 1604.

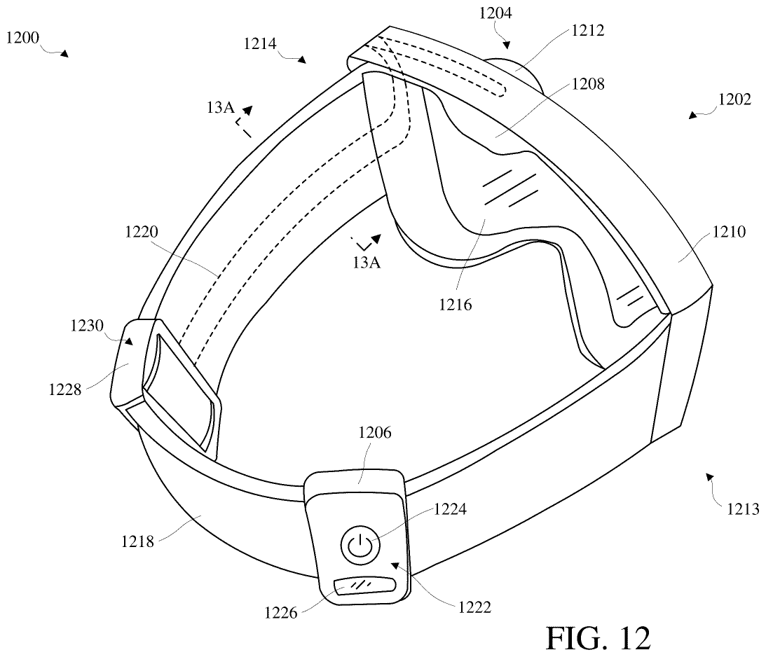

FIG. 17 illustrates a top-down view of the imaging system 1600 shown in FIGS. 16A-16D. As discussed above, the imaging system 1600 may be configured for removable coupling to protective eyewear. The imaging system 1600 may also be adapted for coupling to other objects other than protective eyewear. For example, as shown in FIG. 17, the imaging system 1600 may be configured to mount to a structure 1702 via a mounting plate 1704. The structure 1702 may be a vehicle structure, a building structure, or any other structure.

As shown in FIG. 17, the mounting plate 1704 may define one or more apertures, such as the apertures 1706. The apertures 1706 may define through-holes or other openings through a thickness of the mounting plate 1704 such that one or more fasteners (e.g., bolts, screws, pins, etc.), such as the fasteners 1708, may extend through the mounting plate 1704 and into the structure 1702 to secure the mounting plate 1704 to the structure 1702. The mounting plate 1704 may also include one or more connectors, such as the connectors 1710, to couple the body 1658 of the control module 1606 to the mounting plate 1704, thereby connecting the control module 1606 to the structure 1702. The connectors 1710 may be projections or other engagement features that engage the control module 1606. For example, the connectors 1710 may be studs or buttons that are received by keyholes defined by the body 1658 of the control module 1606 to removably couple the control module 1606 to the mounting plate 1704.

The image capture device 1604 may also be connected to the structure 1702 or an additional structure via a bracket 1712. For example, the bracket 1712 may extend around all or a portion of the wiring 1618 of the imaging system 1600 such that the bracket 1712 may clip to the body 1650 of the image capture device 1604. As such, the bracket 1712 may then be secured to the structure 1702 or an additional structure via one or more fasteners extending through the bracket 1712 or any other connection means (e.g., mechanical interlock, adhesive, etc.)

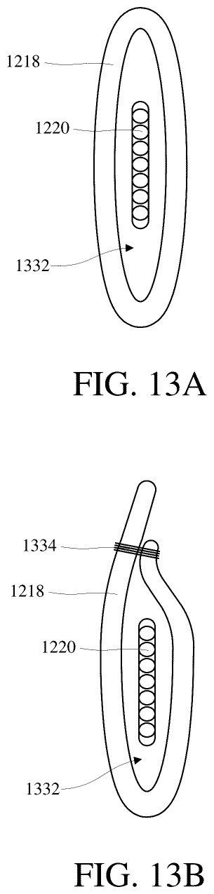

FIG. 18 illustrates a front view of the mounting plate 1704 shown in FIG. 17. As described above, the mounting plate 1704 may include a plurality of connectors 1710 configured to couple the control module 1606 to the mounting plate 1704. The mounting plate 1704 may also define the apertures 1706, which may be holes or slots in the mounting plate 1704, that may receive the fasteners 1708 to secure the mounting plate 1704 to the structure 1702. It should be noted that the mounting plate 1704 may be any size and/or shape. Similarly, the connectors 1710 and/or the apertures 1706 may be positioned anywhere along the mounting plate 1704 to facilitate connection between the mounting plate 1704 and the control module 1606.

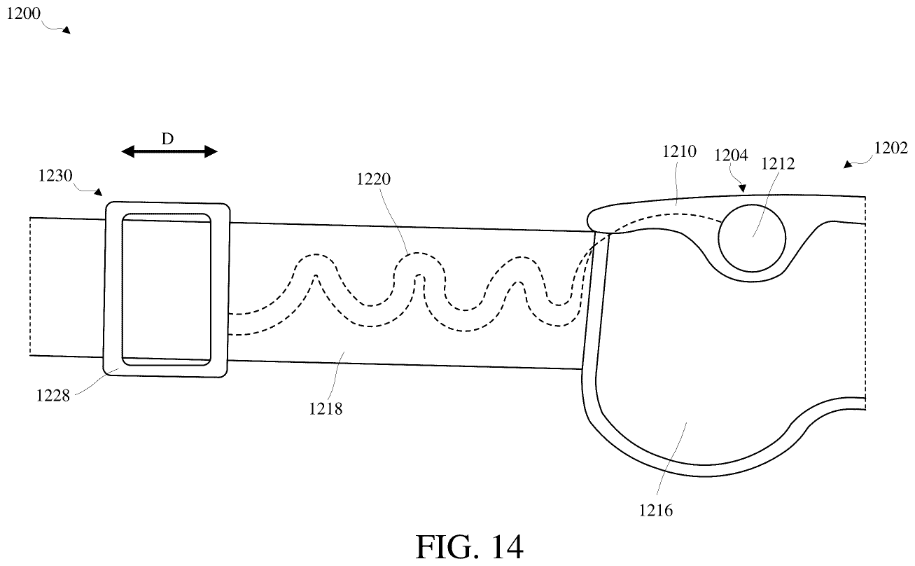

FIG. 19A illustrates a perspective view of an imaging system 1900 coupled to another example of protective eyewear 1902. The imaging system 1900 may be similar to the imaging system 1500 shown in FIGS. 15A-15C, or the imaging system 1600 shown in FIGS. 16A-17. For example, similar to the imaging system 1500 of FIGS. 15A-15C, the imaging system 1900 may be configured for removable coupling to the protective eyewear 1902. The protective eyewear 1902 may be any type of protective eyewear. By way of example, as shown in FIG. 19A, the protective eyewear 1902 may be a pair of sunglasses or safety glasses, further illustrating that the imaging systems described herein may be implemented with any type of protective eyewear.

The imaging system 1900 may include an image capture device 1904 and a control module 1906 configured to power and/or operate the image capture device 1904. As discussed further below, the image capture device 1904 and the control module 1906 may be removably coupled to the protective eyewear 1902. That is, the image capture device 1904 and the control module 1906 may be removably coupled to the protective eyewear 1902 such that the imaging system 1900 may be operated when coupled to the protective eyewear 1902 and the protective eyewear 1902 is worn by a user. For example, as shown in FIG. 19A, the imaging system 1900 (e.g., the image capture device 1904) may be configured to removably coupled to a frame 1910 of the protective eyewear 1902.

The image capture device 1904 and the control module 1906 may be configured for removable coupling to and from the exterior of the protective eyewear 1902, such as a first side 1912 and/or a second side 1914 of the protective eyewear 1902. For example, the frame 1910 may include one or more receiving portions on the first side 1912 and/or the second side 1914, which may be similar to the receiving portion 1508 of the protective eyewear 1502 described above and shown in FIGS. 15A-15C. The receiving portions of the frame 1910 may facilitate removably coupling of the image capture device 1904 to the frame. For example, the image capture device 1904 may include a connecting portion that is similar to the connecting portion 1532 of the image capture device 1504 shown in FIG. 15C, and the connecting portion of the image capture device 1904 may be received by a receiving portion of the frame 1910 to removably couple the image capture device 1904 to the protective eyewear 1902. However, the image capture device 1904 may be removably coupled to the frame 1910 in any desired manner, including those techniques described above with respect to the imaging system 1500 shown in FIGS. 15A-15C.

As shown in FIG. 19A, the control module 1906 may be spaced apart from the image capture device 1904 and connected to the image capture device 1904 by wiring 1918 extending therebetween. The wiring 1918 may be fixedly connected (e.g., hardwired) or removably connected to the image capture device 1904 and/or the control module 1906. The wiring 1918 may facilitate powering of the image capture device 1904 by the control module 1906. For example, the control module 1906 may be or may include a housing 1920 that defines a cavity therein. The housing 1920 may include an openable access panel 1922 (illustrated in FIG. 19A as broken lines to reflect an open position of the access panel 1922), whereby the access panel 1922 may be openable in the direction 1924 to allow a power module 1926 (e.g., a battery) to be inserted into the housing 1920, at which point the access panel 1922 may be closed to contain the power module 1926 within the housing 1920. As a result, the control module 1906 may provide power to the image capture device 1904 via the wiring 1918 to power the image capture device 1904 using the power module 1926.

The wiring 1918 may also facilitate control (e.g., operation) of the image capture device 1904 by the control module 1906. For example, the control module 1906 may include a user input (e.g., a button, toggle, switch, capacitive touch sensor, or other control) that is configured to receive an input from the user to operate the image capture device 1904 (e.g., to initiate and/or stop capturing of images). Such a connection may allow the user to operate the image capture device 1904 via the control module 1906 even when the imaging system 1900 is coupled to the protective eyewear 1902.

The image capture device 1904 may be similar to the image capture device 104 shown in FIG. 1A-1B, one or more of the image capture devices 204, 206 shown in FIG. 2A-2B, one or more of the image capture devices 304, 306 shown in FIG. 3, the image capture device 404 shown in FIG. 4A-4B, an image capture device of the image capture apparatus 500 shown in FIG. 5, or the image capture device 1504 shown in FIGS. 15A-15C. The image capture device 1904 may include, or may be in communication with, one or more additional components of the imaging system 1900. For example, the image capture device 1904 may include a lens assembly located at least partially within a body of the image capture device that may be configured to capture images. However, the image capture device 1904 is not particularly limited to any one configuration.

All or a portion of the imaging system 1900 may be coupled to the frame 1910 of the protective eyewear 1902, a lens 1928 secured to the frame 1910, a strap 1930 of the protective eyewear 1902 configured to secure the protective eyewear 1902 to a head of the user, or a combination thereof. For example, as shown in FIG. 19A, the imaging system 1900 may be coupled to both the frame 1910 (e.g., a temple portion of the frame 1910 that is configured to be positioned adjacent to a temple of the user's head) and the strap 1930. In particular, the image capture device 1904 may be removably (e.g., magnetically, press-fit connection, other mechanical connection, etc.) connected to the frame 1910 (e.g., a receiving portion thereof) and the control module 1906 may be removably (e.g., via one or more clip portions 1932 formed with or connected to the housing 1920 of the control module 1906) coupled to the strap 1930. As shown in FIG. 19A, the control module 1906, via the clip portions 1932, may be adjustable to adjust a position of the control module 1906 along the strap 1930.

Additionally, the strap 1930 may define one or more apertures positioned along the first side 1912 and/or the second side 1914 of the protective eyewear 1902, such as the apertures 1934. The apertures 1934 may define openings in the strap 1930 to permit access to an interior channel of the strap 1930 and/or an opposing side of the strap 1930 (e.g., an interior side of the strap 1930 that may contact the user's head) such that the wiring 1918 of the imaging system 1900 may be routed through or along the strap 1930 to contain the wiring 1918 within or along the strap 1930 when the imaging system 1900 is coupled to the protective eyewear 1902. Additionally, the apertures 1934 may facilitate coupling of the imaging system 1900 to first side 1912 and/or the second side 1914, thereby providing further customization of the imaging system 1900 when connecting the imaging system 1900 to the protective eyewear 1902.

The frame 1910 of the protective eyewear 1902 may also facilitate removably coupling of the strap 1930 to the protective eyewear 1902. By way of example, the frame 1910 may include a quick-release mechanism 1936 (e.g., a quick-release pin, dovetail joint, slot for routing and securing a portion of the strap 1930, clamping portion, etc.) along the first side 1912 that is configured to releasably secure the strap 1930 to the first side 1912 of the frame 1910. The frame 1910 may also include a second quick-release mechanism along the second side 1914 to releasably secure the strap 1930 to the second side 1914 of the frame 1910, thereby securing the strap 1930 to both the first side 1912 and the second side 1914 of the protective eyewear 1902.

Such releasable connection of the strap 1930 to the frame 1910 may also provide further customization of the protective eyewear 1902. For example, FIG. 19B illustrates another perspective view of the protective eyewear 1902 shown in FIG. 19A. In this case, the strap 1930 has been disconnected from the frame 1910 and a pair of arms 1938 have been coupled to the frame 1910 via the quick-release mechanism 1936 located on the first side 1912 of the frame 1910 and the second quick-release mechanism located on the second side 1914 of the frame 1910. As such, the protective eyewear 1902 may facilitate easy interchangeability between the strap 1930 and the arms 1938 to allow the user to customize how the protective eyewear 1902 may be worn.

Additionally, the imaging system 1900 may also be configured for coupling to the protective eyewear 1902 both when the strap 1930 is coupled to the frame 1910, as shown in FIG. 19A, and when the arms 1938 arm are coupled to the frame 1910, as shown in FIG. 19B. For example, as shown in FIG. 19B, the image capture device 1904 may be removably coupled to the first side 1912 of the frame 1910 and the control module 1906 may be removably coupled to the second side 1914 of the frame 1910. The first side 1912 of the frame 1910 and the second side 1914 of the frame 1910 may each include a receiving portion or other means to removably connect the image capture device 1904 and the control module 1906 to the frame 1910. For example, the second side 1914 of the frame 1910 may be configured to secure the control module 1906 via the clip portions 1932 of the housing 1920. In such a configuration, the wiring 1918 may then be routed across the frame 1910, such as along a bridge 1940 of the frame 1910 to maintain electrical connection between the image capture device 1904 and the control module 1906. Thus, the imaging system 1900 may be coupled to the protective eyewear 1902 and worn by the user with either the strap 1930 or the arms 1938, thereby providing additional interchangeability.

Moreover, it is envisioned that a quick-release mechanism similar to the quick-release mechanism 1936 may also be integrated into, or otherwise part of, additional forms of protective eyewear. For example, protective eyewear similar to the protective eyewear 1502 shown in FIGS. 15A-15C, may also include a quick-release mechanism that may removably couple the strap 1930 to the protective eyewear 1502. As a result, the strap 1930 may be easily disconnected from the protective eyewear 1902 and connected to the protective eyewear 1502 of FIGS. 15A-15C. Thus, the strap 1930 may be interchanged with various types of protective eyewear, such as googles, sunglasses, safety glasses, or other types of protective eyewear.

Such interchangeability may also facilitate coupling of the imaging system 1900 to additional wearable garments other than protective eyewear. For example, the imaging system 1900 may be disconnected from the protective eyewear 1902 and/or the strap 1930 such that the imaging system 1900 may be removably coupled to another garment, such as a hat (e.g., hardhat, baseball cap, beanie, helmet, etc.), shirt, jacket, lanyard, visor, or other type of garment. Thus, the imaging system 1900 may enable easy connection and disconnection of the imaging system 1900 from various types of wearable items.

In addition to integrating an imaging system into protective eyewear as described above, the modularity of the imaging systems described herein may also be configured for mounting to a visor through use of mounting mechanisms. For example, the imaging system may include a first interconnect mechanism and the visor may include a second interconnect mechanism such that the first interconnect mechanism may engage the second interconnect mechanism to thereby secure the imaging system, or a portion thereof, to the visor. The visor may be configured for use with any type of helmet, such as a motocross helmet, a skydiving helmet, or a dirt bike helmet. By way of example, the imaging system may be coupled to the visor, which may thereafter be coupled (e.g., removably coupled) to the helmet to allow the user to capture images and/or video as the user wears the helmet and performs an activity (e.g., cycling, biking, skydiving, skiing, boating, etc.).

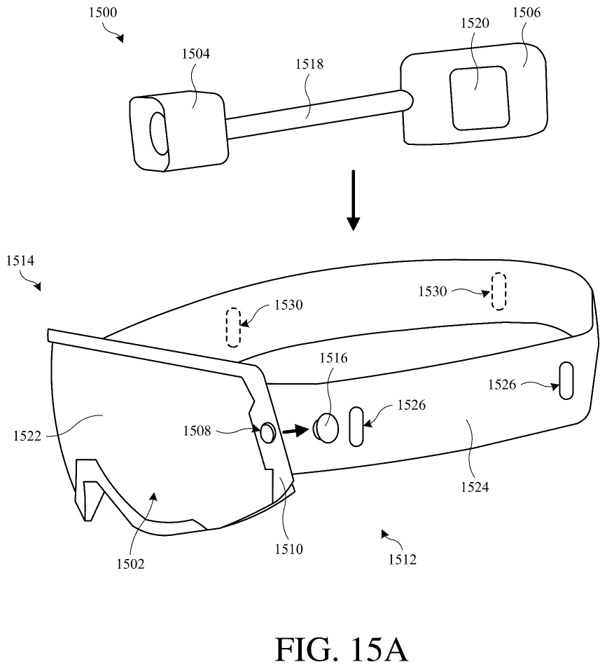

To further illustrate, FIG. 20 shows a perspective view of an imaging system 2000 with a mounting mechanism 2002. The imaging system 2000 may be small in size and light in weight such that the imaging system 2000 is highly portable. The imaging system may include an imaging unit 2004, which may be disposed in a body 2006 of the imaging system 2000. The imaging unit 2004 may include an optical element such as a lens 2008 that captures light for the imaging unit 2004. The lens 2008 may be a standard lens, a macro lens, a zoom lens, a special-purpose lens, a telephoto lens, a prime lens, an achromatic lens, an apochromatic lens, a process lens, a wide-angle lens, an ultra-wide-angle lens, a fisheye lens, an infrared lens, an ultraviolet lens, a perspective control lens, an anamorphic lens, another lens, and/or another optical element.

The lens 2008 of the imaging unit 2004 may focus captured light onto one or more image sensors. The image sensors may include one or more of a charge-coupled device (CCD) sensor, an active pixel sensor (APS), a complementary metal-oxide semiconductor (CMOS) sensor, an N-type metal-oxide-semiconductor (NMOS) sensor, and/or another image sensor. The image sensor may capture light waves gathered by the lens 2008 to produce image data based, for example, on control signals from the imaging unit 2004. The imaging unit 2004 may also include an integrated and/or removable battery and a limited, integrated and/or removable electronic storage that may store image data produced by the image sensor.

In some examples, the imaging unit 2004 may communicate with another device in order to send and/or receive commands, send and/or receive image information, and/or perform imaging operations. For example, the imaging system 2000 may include wireless (or wired) communication capabilities to interface with a helmet, smart phone, tablet, smart watch, etc., in order to use camera applications, social media applications, gaming applications, messaging applications, fitness or monitoring applications, settings applications, etc. The imaging unit 2004 may include the ability to both capture and transfer still images and/or video for use with the above applications. Transfer may occur via a wired connection or wirelessly, for example, using WiFi or BTLE.

The imaging system 2000 may include a control interface, such as one or more buttons 2010. As shown in FIG. 20, the control interface (e.g., the buttons 2010) may be disposed on a side surface of the body 2006 of the imaging system 2000, though other locations for the control interface, such as the top surface of the body 2006 of the imaging system 2000, are also possible. The control interface may be used to provide commands to the imaging unit 2004, such as to capture an image, start and/or stop capturing video, start and/or stop charging, start and/or stop data transfer, or other commands, for example, taking the form of various combinations of presses or taps against the one or more of the buttons 2010. Though the control interface shown here is the buttons 2010, other interfaces such as audio interfaces, sliders, touch pads, capacitive sensors, heat sensors, and/or other interfaces may be used to receive commands from a user for the imaging unit 2004.

The imaging system 2000 may include one or more sensors 2012, for example, disposed on an upper surface of the body 2006 of the imaging system 2000 or in communication with the imaging unit 2004 and/or the control interface. The sensors 2012 may be configured to capture proximity information, audio information (e.g., using a microphone to capture voice commands), biometric information (e.g., using a proximity sensor, a heart rate sensor, a heat detection sensor, and/or a sensor that determines gaze direction), or any other information useful for the imaging unit 2004 to configure operation of the imaging system 2000. For example, the sensors 2012 may include an accelerometer and/or gyroscope configured to determine user interaction with the imaging system 2000 representative of intended recording or capture by the imaging system 2000.

The imaging system 2000 may include an I/O module, such as the I/O module 2014 shown in FIG. 20 as dashed lines associated with a back surface or rear surface of the body 2006 of the imaging system 2000. The I/O module 2014 may include a wired interface (e.g., USB, USB-C, HDMI, and/or other interfaces) configured to communicate to one or more external devices. For example, the I/O module 2014 may include a wired power interface to an external energy source (e.g., a battery, a DC electrical source, and/or other energy sources) that supplies charge to the imaging unit 2004.

The imaging system 2000 may also include an indicator 2016, for example, in the form of a light-emitting device (e.g., LED) or an audio speaker. The indicator 2016 may be used to provide a mode indication, a power indication, a connection indication, or other information relevant to operation of the imaging system 2000 to the user and/or to other individuals nearby the user.

The imaging system 2000 of FIG. 20 includes the body 2006, which may be bullet-like or lipstick-like in shape. In other examples, the body 2006 may have a rectangular shape, cubic shape, spherical shape, and/or any other shape suitable both for easy portability and for image capture by the imaging unit 2004. The imaging system 2000 may be water resistant and/or waterproof to a specified depth (e.g., between 1 m to 10 m) such that the imaging system 2000 may be used to capture images and video in wet or moist environments.

As discussed above, the imaging system 2000 may include the mounting mechanism 2002, which may include a mounting component 2018. The mounting component 2018 shown in FIG. 20 is a pair of fingers or protrusions in an extended position. The fingers or protrusions may also be collapsible into a collapsed position, such as via rotation about hinges or through a spring mechanism that allows extension from and retraction into the body of the image capture device. The mounting component 2018 may be described as an interconnect mechanism. The interconnect mechanism may be configured to couple the imaging system 2000 to other components, such as the visor of a helmet as described further herein. To achieve coupling, the interconnect mechanism (e.g., the mounting component 2018) may interface with a corresponding interconnect mechanism on another component, such as by interleaving of the extended fingers or protrusions, each of which includes a through-hole. A connector (e.g., a threaded connector such as a thumbscrew, set screw, etc.) may then extend across the interleaved through holes to achieve coupling. Assembled as described, when a user wears a helmet with a visor that includes the interconnect mechanism that receives the interconnect mechanism of the imaging system 2000, the imaging system 2000 may be positioned in a manner that allows capture of a viewpoint that would be consistent with a viewpoint of the user wearing the helmet and the visor.

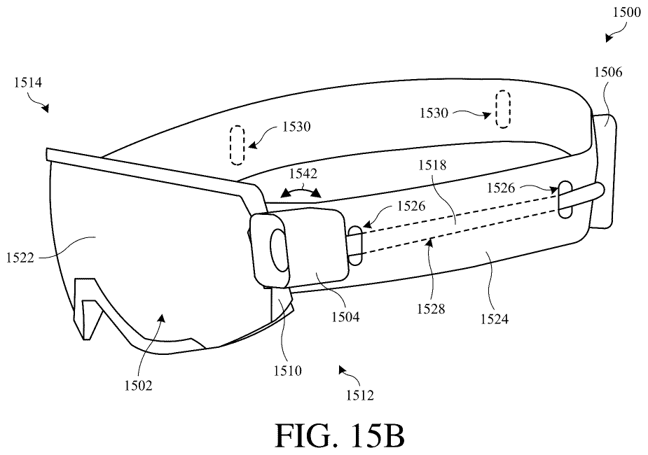

FIG. 21 is an illustration of a visor 2100 including another mounting component 2102 configured to couple to the mounting component 2018 of the imaging system 2000 of FIG. 20. The visor 2100 is configured for use with a helmet 2104, such as above an eye opening 2106 of the helmet 2104. The visor 2100 may be described as a brim, a cap, or a brow. The visor 2100 may be removable from the helmet 2104, such as through use of clips, buttons, clamps, or pins to couple to holes at distal edges of the visor 2100. For example, as shown in FIG. 21, the visor 2100 may define openings 2108, which may receive respective pins or clips of the helmet 2104 to secure the visor 2100 to the helmet 2104. The mounting component 2102 on the visor of FIG. 21 is an interconnect mechanism coupled to the visor 2100. The interconnect mechanism includes three fingers or protrusions shown in an extended position. The interconnect mechanism of FIG. 21 is configured to couple with the interconnect mechanism associated with the imaging system 2000 (e.g., the mounting component 2018 of the imaging system 2000), such as by interleaving and use of a connector or other fastener. In other words, the mounting component 2102 of the visor 2100 is configured to couple to the mounting component 2018 of the imaging system 2000 to secure the imaging system 2000 to the visor 2100.

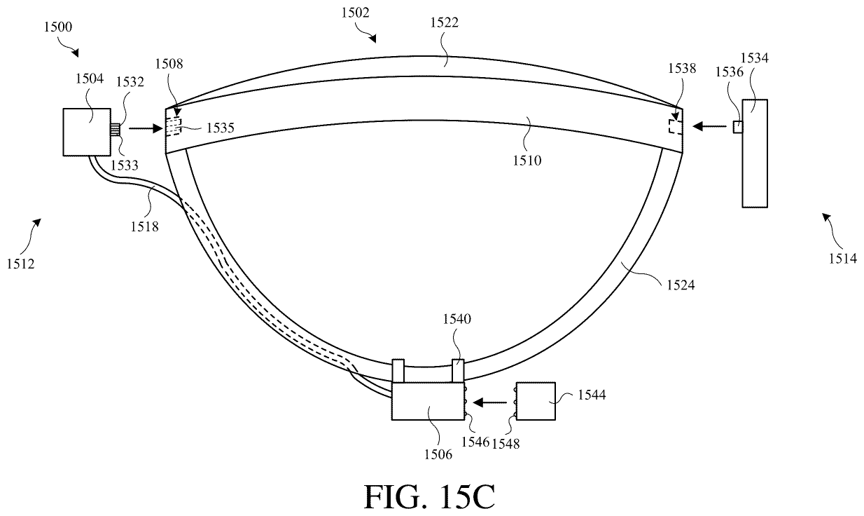

FIG. 22 is an illustration of another visor 2200 including a mounting component 2202 configured to couple to the mounting component 2018 of the imaging system 2000 of FIG. 20. In FIG. 22, the mounting component 2202 is an interconnect mechanism coupled to an interior surface 2204 of the visor 2200. That is, the interconnect mechanism is shown in dashed line as below the visor 2200, on a lower surface of the visor, or beneath the brim of the visor 2200. The visor 2200 in FIG. 22 is also configured for use with a helmet 2206, such as above an eye opening 2208 of the helmet 2206. The visor 2200 may be removable from the helmet 2206, such through use of clips or pins to couple to holes 2210 at distal edges of the visor 2200. The interconnect mechanism of FIG. 22 also includes three fingers or protrusions shown in an extended position, though fewer fingers or protrusions, such as one or two, are also possible. The interconnect mechanism is configured to couple with the interconnect mechanism (e.g., the mounting mechanism 2002) associated with the imaging system 2000 of FIG. 20, such as by interleaving and use of a connector or other fastener to extend through aligned through holes.

When the imaging system 2000 of FIG. 20 is coupled to the visor 2100 of FIG. 21 or the visor 2200 of FIG. 22 via the respective interconnect mechanisms, an imaging axis of the imaging system 2000 may be generally parallel with a line of sight of a user of the visor (e.g., the visor 2100 or the visor 2200) and the helmet (e.g., the helmet 2104 or the helmet 2206). To support capture of an accurate viewpoint, the interconnect mechanism (e.g., the mounting component 2102 of the visor 2100 or the mounting component 2202 of the visor 2200) may be repositionable on an outer surface (e.g., an upper surface or an exterior surface as in FIG. 21) or an inner surface (e.g.,, a lower surface or the interior surface 2204 as in FIG. 22) as shown by the directional arrows in FIGS. 21 and 22. The interconnect mechanism (e.g., the mounting component 2102 of the visor 2100 or the mounting component 2202 of the visor 2200) may be removable from their respective visor, for example, if attached via a reusable adhesive. In other embodiments, the interconnect mechanism (e.g., the mounting component 2102 of the visor 2100 or the mounting component 2202 of the visor 2200) may be integral with their respective visor.

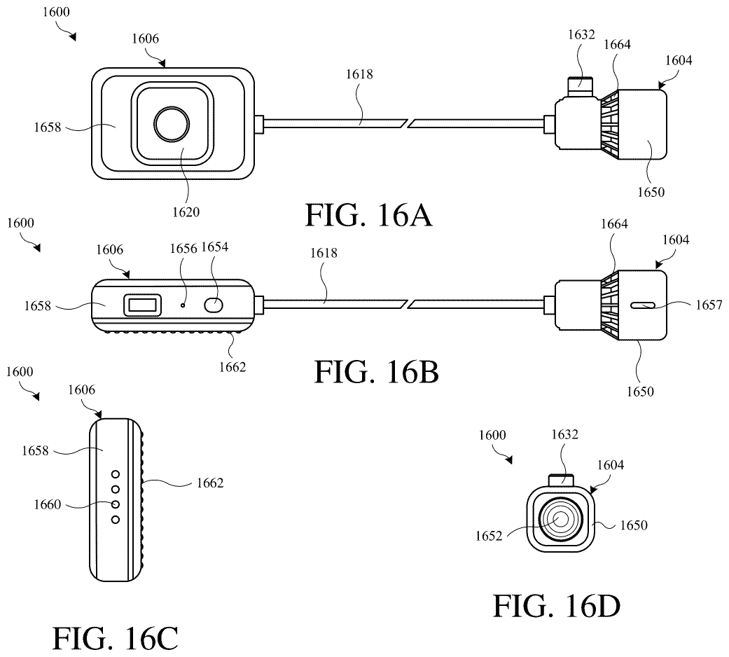

FIG. 23 is an illustration of the imaging system 2000 of FIG. 20 configured to couple to a visor 2300 in a first configuration. The visor 2300 may be coupled to a helmet, such as the helmet 2104 of FIG. 21 or the helmet 2206 of FIG. 22. The visor 2300 may be removably coupled to or fixedly integrated with the helmet. A user may desire to wear the helmet when performing an activity, such as biking, skydiving, boating, skiing, etc., and may desire to record images or video of the activity to share with others (e.g., via social media, private messages, etc.). Prior to donning the visor 2300 and/or the helmet, the user may secure the imaging system 2000 to a mounting surface (e.g., an interior surface 2302) of the visor 2300 in a desired orientation. As shown in FIG. 23, the user may secure the imaging system 2000 to the visor 2300 using an adhesive 2304, such as a reusable adhesive, in a manner that orients the imaging system 2000 in a direction approximately parallel to a line of sight of a face of the user. For example, the user may desire to record the activity to provide a “first person view” of the activity. For example, when another person views the video, the user may desire the other person to view the activity through the eyes of the user (e.g., to feel as though the other person is performing the activity).

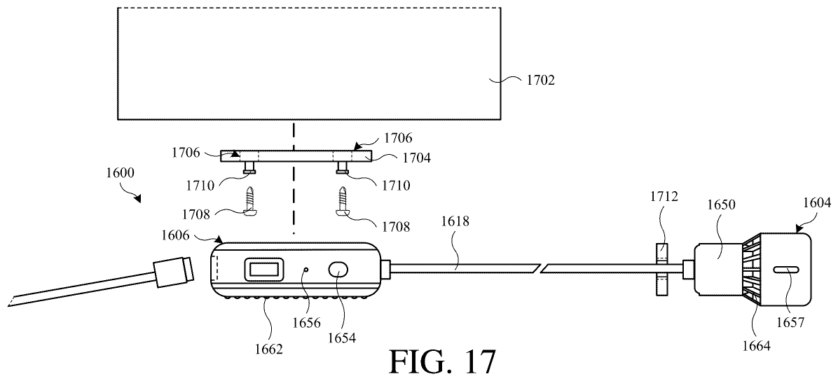

FIG. 24 is an illustration of the imaging system 2000 of FIG. 20 coupled to a visor 2400 in a second configuration. In the example of FIG. 24, the visor 2400 includes a housing 2402 for the imaging system 2000 disposed on an upper surface 2404 (e.g., an exterior surface) of the visor 2400. The imaging system 2000 may be able to slide into and out of the housing 2402. When the imaging system 2000 is coupled to the visor 2400, and the visor 2400 attached to a helmet worn by a user, an imaging axis of the imaging system 2000 may be generally parallel with a line of sight of the user. One or more electronic components, such as subcomponents of the imaging system 2000 or control components separate from the imaging system 2000, may be disposed within the visor 2400.

For example, an electronic control module may include a printed circuit board 2406 that is housed within an interior of the visor as shown as dashed lines in FIG. 24. Housing subcomponents of the imaging system 2000 and/or components that support communication with or control of the imaging system 2000 within an interior of the visor 2400 allows for a reduced size of the imaging system 2000 that protrudes above (or below) the visor 2400. For example, the visor 2300 of FIG. 23 may include subcomponents of the imaging system 2000 as shown in dashed line in the visor 2400 of FIG. 24. Such a visor with embedded electronic components may allow for a smaller size of the imaging system 2000 that is coupled to an interior surface 2302 of the visor 2300. A smaller size of the imaging system 2000 may reduce interference with a line of sight of the user wearing the visor 2300 of FIG. 23.

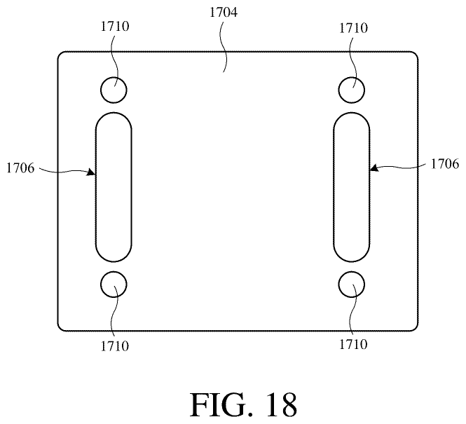

FIG. 25 is an illustration of another imaging system 2500 coupled to a visor 2502 in a third configuration. In the example of FIG. 25, the visor 2502 includes a recessed section or slot configured to receive a claw portion or a clamp portion, such as the clamp portion 2504, of a body 2506 of the imaging system 2500. In this manner, a first portion 2508 of the imaging system 2500 is disposed above an exterior surface 2510 of the visor 2502 and a second portion 2512 of the imaging system 2500 is disposed below an interior surface 2514 of the visor 2502. The clamp portion 2504 may include a retention mechanism sufficient to retain the imaging system 2500 to the visor 2502, such as a spring, a hinge, a lock, or a friction fit between the clamp portion 2504 and the recessed section of the visor 2502. In some examples, no recessed portion is present on the visor 2502. In the example of FIG. 25, when the imaging system 2500 is coupled to the visor 2502, an imaging axis of the imaging system 2500 may be generally parallel with a line of sight of a user of the helmet (e.g., the helmet 2104 of FIG. 21 or the helmet 2206 of FIG. 22) that includes the visor 2502. The imaging axis of the imaging system 2500 may also be configured to extend along a common plane with the visor 2502. In this way, the imaging system 2500 may be easily able to avoid capturing the visor 2502 in images or video.

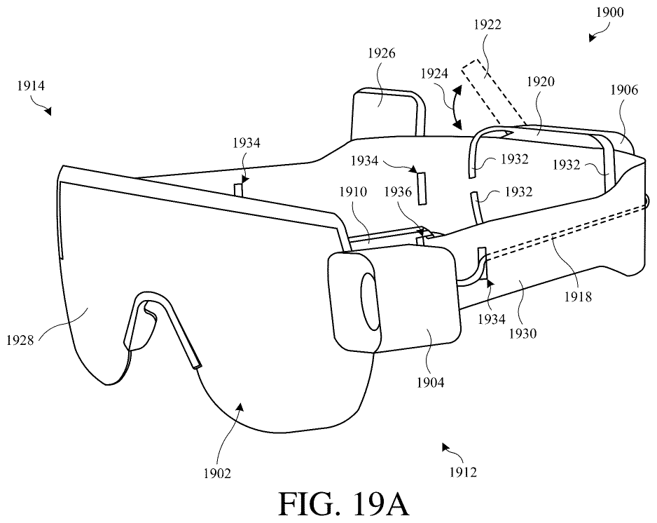

FIG. 26 is an illustration of another imaging system 2600 coupled to a visor 2602 and a power source 2604 (e.g., a battery). In the example of FIG. 26, the visor 2602 includes a housing 2606 for the imaging system 2600 disposed on an upper surface 2608 (e.g., an exterior surface) of the visor 2602. The housing 2606 may include buttons or switches, such as the buttons 2610, allowing a user to interact with the imaging system 2600, for example, to provide commands to start capture, stop capture, turn on, or turn off the imaging system 2600. One or more wires, such as the wire 2612, may extend between the imaging system 2600 and the power source 2604, for example, to provide power to the imaging system 2600. The power source 2604 may be disposed at a remote location, such as within the helmet (e.g., the helmet 2104 of FIG. 21 or the helmet 2206 of FIG. 22) that includes the visor 2602. By locating the power source 2604 remotely from the imaging system 2600 that is disposed on the visor 2602, a weight of the imaging system 2600 may be reduced.

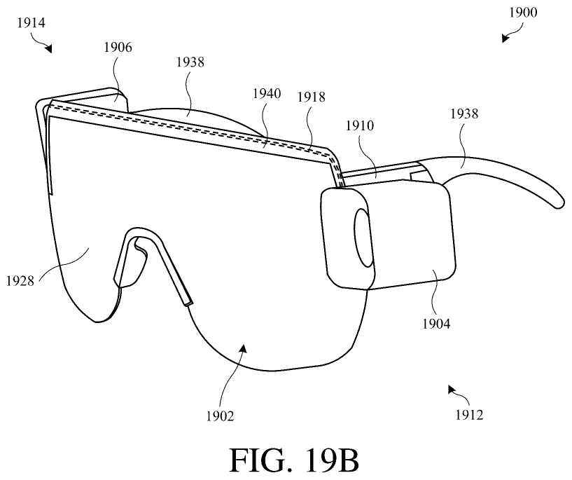

FIG. 27 is an illustration of another imaging system 2700 coupled to a visor 2702, a power source 2704, and a remote computing device 2706. In the example of FIG. 27, the visor 2702 includes a housing 2708 for the imaging system 2700 disposed on an upper surface 2710 (e.g., an exterior surface) of the visor 2702. The housing 2708 includes buttons or switches, such as the buttons 2712, allowing a user to interact with the imaging system 2700, for example, to provide commands to start capture, stop capture, turn on, or turn off the imaging system 2700. One or more wires, such as the wire 2714, may extend between the imaging system 2700 and an electronic module 2716, for example, to provide both control features and power to the imaging system 2700. As shown in FIG. 27, the electronic module 2716 may contain or include the power source 2704 and the remote computing device 2706 to provide both control features and power to the imaging system 2700. For example, the electronic module 2716 may be or may include a housing that contains the power source 2704 (e.g., a battery) and/or the remote computing device 2706. The electronic module 2716 may be disposed at a remote location, such as within or coupled to the helmet (e.g., the helmet 2104 of FIG. 21 or the helmet 2206 of FIG. 22) that includes the visor 2702. The electronic module 2716 may be worn by the user in another manner, such as on a pendant. By locating the electronic module 2716 remotely from the imaging system 2700 that is disposed on the visor 2702, a weight of the imaging system 2700 may be reduced. In the example shown in FIG. 27, the imaging system 2700 is smaller than the imaging system 2500 of FIG. 25 and the imaging system 2600 of FIG. 26.

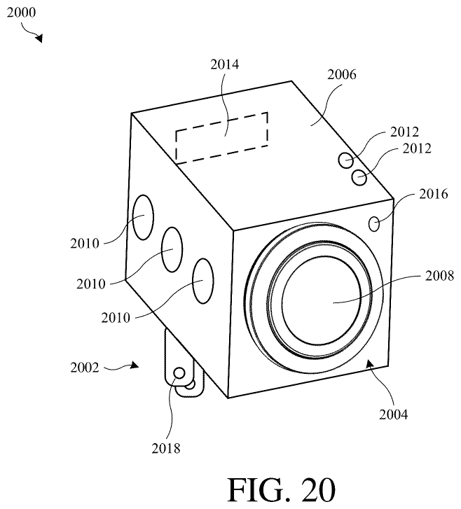

FIG. 28 illustrates a perspective view of an imaging system 2800 coupled to protective eyewear 2802. The imaging system 2800 may be configured for removably coupling to an exterior of the protective eyewear 2802. By way of example, the imaging system 2800 may be configured to removably coupled to any type of protective eyewear, such as ski or snowboard goggles, motorcycling goggles, motocross goggles, sunglasses, other types of protective eyewear, or a combination thereof. For illustrative purposes, the protective eyewear 2802 shown in FIG. 28 is a pair of goggles configured to be worn by a skier or snowboarder.

The imaging system 2800 may be similar to the imaging system 1600 of FIGS. 16A-16D. For example, the imaging system 2800 may include an image capture device 2804 and a control module 2806 configured to power and/or operate the image capture device 2804. The image capture device 2804 and/or the control module 2806 may be removably coupled to the protective eyewear 2802 such that the imaging system 2800 (e.g., the image capture device 2804) may be operated when coupled to the protective eyewear 2802 and the protective eyewear 2802 is worn by the user. For example, the imaging system 2800 may be removably coupled to a strap 2808 of the protective eyewear 2802 by an attachment 2810. The strap 2808 may be secured to a frame 2812 of the protective eyewear 2802 that secures a lens 2814 of the protective eyewear 2802 such that the strap 2808 extends between a first side 2816 and an opposing second side 2818 of the frame 2812. As such, the strap 2808 may secure the protective eyewear 2802 to the head of the user.

To secure the imaging system 2800 to the strap 2808, the attachment 2810 may include a clip portion 2820. The clip portion 2820 may define a receiving portion or other engagement means such that the clip portion 2820 may be secured to the strap 2808 and remain in a desired position when the protective eyewear 2802 is worn by the user. For example, the clip portion 2820 may frictionally engage the strap 2808 or otherwise clamp down on the strap 2808 to secure the attachment 2810 to the strap 2808.

As discussed further below, the attachment 2810 may further include an arm which couples to the image capture device 2804 of the imaging system 2800 to secure the image capture device 2804 to the attachment 2810 and thus to the strap 2808. The arm may be movable with respect to the clip portion 2820 to provide further adjustability to a position of the image capture device 2804 to ensure a field of view of the image capture device 2804 is unobstructed by the user and/or the protective eyewear 2802. For example, the arm—and thus the image capture device 2804—may be rotatable with respect to the clip portion 2820 and/or may translate with respect to the clip portion 2820. By way of example, the clip portion 2820 may define a slot 2822 therein, whereby the arm—and thus the image capture device 2804—may slide along the slot 2822 in a direction (D) to move the image capture device 2804 up and down with respect to the clip portion 2820 in an elevational direction of the protective eyewear 2802 (e.g., towards a top or bottom of the strap 2808). Thus, the image capture device 2804 may be movably coupled to the strap 2808.

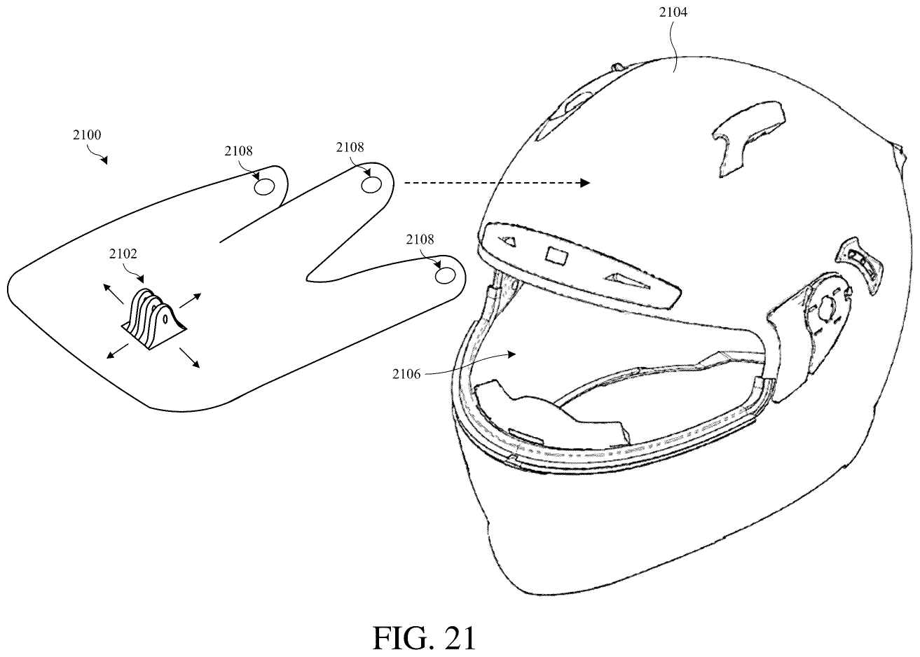

The control module 2806 may also be coupled to the protective eyewear 2802 and/or another location remote from the protective eyewear 2802. For example, the control module 2806, which may be connected to the image capture device via wiring 2824, may also be secured to the strap 2808 using a clip or other attachment means. Alternatively, or additionally, the control module 2806 may be connected to another accessory or an article of clothing using an interconnect mechanism 2826 of the control module 2806. The interconnect mechanism 2826 may be a pair of tabs or other engagement means that may be secured (e.g., removably secured) to an external device (e.g., a motocross bike, ski pole, helmet, etc.) and/or an article or clothing (e.g., jacket, shirt, hat, etc.). The clip or interconnect mechanism 2826 of the control module 2806 described above may also be used with other imaging systems described herein, such as the imaging system 1500 of FIGS. 15A-15C, the imaging system 1600 of FIGS. 16A-16D, or the imaging system 19A-19B. Additionally, the interconnect mechanism 2826 is not limited to any particular type of mechanism, and the tabs shown in FIG. 28 are for illustrative purposes. Moreover, in some configurations, depending on a length of the wiring 2824, the control module 2806 may be placed within a pocket of the clothing worn by the user (e.g., a pocket of a coat). As such, the interconnect mechanism 2826 need not be used to secure the control module 2806. FIGS. 29A and 29B illustrate side views of the attachment 2810 shown in FIG. 28 coupled to the protective eyewear 2802. The attachment 2810 may also be used with other imaging systems described herein, such as the imaging system 1500 of FIGS. 15A-15C, the imaging system 1600 of FIGS. 16A-16D, or the imaging system 19A-19B. As such, use of the attachment 2810 with the image capture device 2804 is only intended for illustrative purposes.

The attachment 2810 may include an arm 2902 that is rotatable (e.g., pivotable) relative to the clip portion 2820 in a direction (R). As such, the arm 2902 may swing towards and away from the clip portion 2820 in the direction (R) to adjust a position of the image capture device 2804 relative to the clip portion 2820. For example, the arm 2902 may define or may include a receiving portion 2904, which may receive an engaging portion of the image capture device 2804 to removably couple the image capture device 2804 to the arm 2902. The image capture device 2804 may include any engaging portion that may facilitate connection of the image capture device 2804 to the arm 2902 (e.g., to the receiving portion 2904). For example, the image capture device 2804 may include a projection, which may be similar to the connecting portion 1632 of the imaging system 1600 of FIGS. 16A-16D, that is received by the receiving portion 2904 of the arm 2902. As such, the image capture device 2804 may also be rotatable relative to the arm 2902 (e.g., via a rosette connection) to facilitate even further adjustment of the position of the image capture device 2804. Thus, the image capture device 2804 may rotate with respect to the arm 2902, the arm 2902 may rotate in the direction (R) relative to the clip portion 2820, and the arm 2902 may translate (e.g., slide) in the direction (D) relative to the clip portion 2820 to adjust the position of the image capture device 2804 relative to the clip portion 2820.

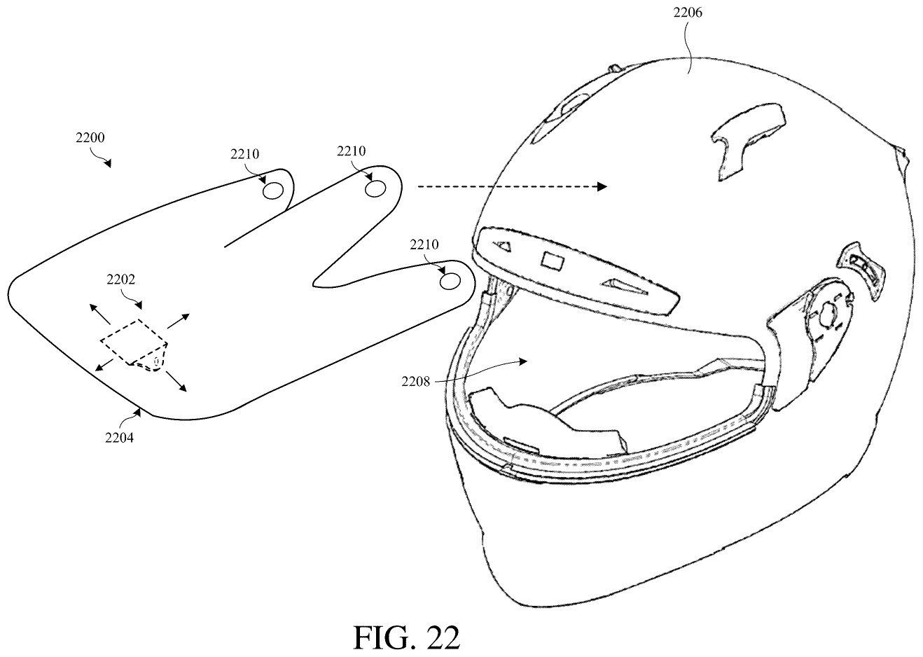

FIG. 30 illustrates another example of an imaging system 3000 configured for coupling to the attachment 2810 of FIGS. 29A and 29B. The imaging system 3000 may be similar to the imaging system 1600 of FIGS. 16A-16D or the imaging system 2800 of FIG. 28.

For example, the imaging system 3000 may include an image capture device 3004 that may be coupled to a control module (e.g., similar to the control module 2806 of the imaging system 2800) via wiring 3006. To secure the image capture device 3004 to the attachment 2810, a body 3008 of the image capture device 3004 may define an aperture 3010 therein. The aperture 3010 may receive a portion of a ball stud 3012 or other projection (e.g., other stud, fastener, pin, etc.). For example, a base of the ball stud 3012 may be threaded into the aperture 3010 to secure the ball stud 3012 to the body 3008 of the image capture device 3004. Once the ball stud 3012 is secured to the body 3008, the ball portion (e.g., rounded portion) of the ball stud 3012 may be inserted into the receiving portion 2904 of the arm 2902 of the attachment 2810 to couple the image capture device 3004 to the attachment 2810. As such, the receiving portion 2904 may be a socket that receiving the ball stud 3012 (e.g., the rounded portion of the ball stud 3012) therein.

To provide even further customization, the imaging system 3000 may include a removable lens 3014. The removable lens 3014 may be any type of lens, such as a standard lens, a macro lens, a zoom lens, a special-purpose lens, a telephoto lens, a prime lens, an achromatic lens, an apochromatic lens, a process lens, a wide-angle lens, an ultra-wide-angle lens, a fisheye lens, an infrared lens, an ultraviolet lens, a perspective control lens, an anamorphic lens, another lens, and/or another optical element. Thus, image capturing using the image capture device 3004 may be customized for various types of activities and/or environments.

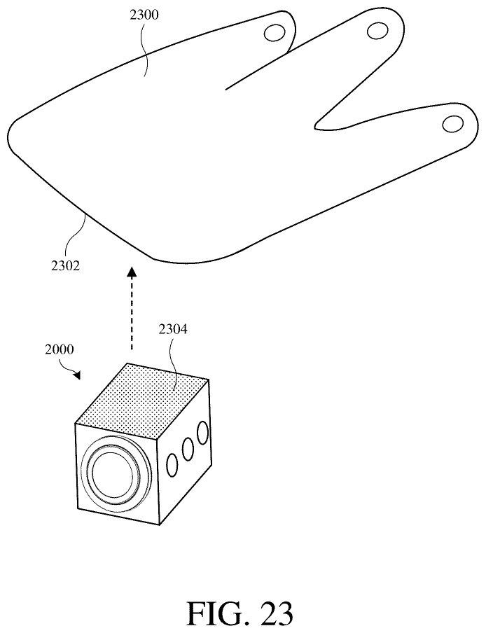

FIG. 31 is a perspective view of another example of an attachment 3100. The attachment 3100 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to various items, such as the protective eyewear, helmets, and visors disclosed herein. For example, the attachment 3100 may removably secure the imaging system to the strap 2808 of the protective eyewear 2802.

The attachment 3100 may include a body 3102 that forms an overall size and/or shape of the attachment 3100. The body 3102 may define a channel 3104 (e.g., slot, groove, notch, cutout, etc.) therein that may receive a portion of the various items discussed above (e.g., the strap 2808 of the protective eyewear 2802). Teeth, knurling, or other frictional surfaces may be present within the channel 3104 to further improve engagement between the attachment 3100 and a portion of the item received therein. The attachment 3100 may also define a receiving portion 3106 that is configured to receive a portion of the imaging system to secure the imaging system to the attachment 3100. By way of example, the imaging system may have an image capture device that includes a ball stud, which may be similar to the ball stud 3012 of the imaging system 3000 of FIG. 30. The ball stud may then be inserted into the receiving portion 3106 (e.g., a ball socket) to secure the image capture device to the body 3108, at which point the attachment 3100 may be clipped to the desired item.

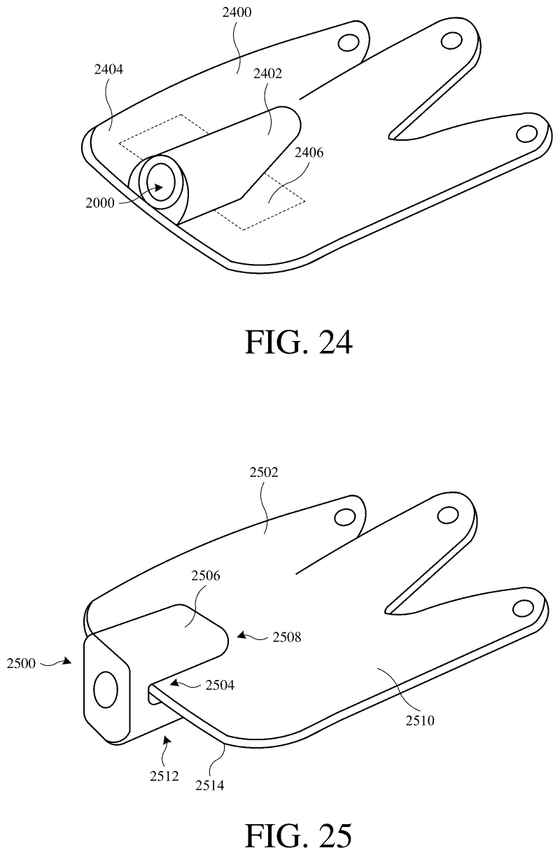

FIG. 32 illustrates another example of an attachment 3200. The attachment 3200 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to protective eyewear, such as the protective eyewear 3202 shown in FIG. 32. For illustrative purposes, the protective eyewear 3202 is shown as a pair of goggles that includes a frame 3204 having a lens 3206 secured therein and a strap 3208 to secure the protective eyewear 3202 to the head of the user.

The attachment 3200 may include a body 3210, which may substantially define an overall size and/or shape of the attachment 3200. The body 3210 is not particularly limited to any particular geometry. For example, the body 3210 may be generally sized so that the body 3210 may be secured to a portion of the frame 3204 of the protective eyewear 3202, such as along or near a temple of the user when the user is wearing the protective eyewear 3202. The body 3210 may define a receiving portion 3212 therein that is configured to receive a portion of the imaging system to secure the imaging system to the attachment 3200. By way of example, the imaging system may have an image capture device that includes a ball stud, which may be similar to the ball stud 3012 of the imaging system 3000 of FIG. 30. The ball stud may then be inserted into the receiving portion 3212 (e.g., a ball socket) to secure the image capture device to the body 3210, at which point the attachment 3200 may be secured to the protective eyewear 3202.

For example, the attachment 3200 may include an adhesive 3214, which may be adhered to the frame 3204 to secure the image capture device to the frame 3204. The adhesive may be disposed on a surface of the body 3210 that opposes a surface that defines an opening for the receiving portion 3212. As such, the image capture device of the imaging system may be positioned such that a field of view of the image capture device is unobstructed by the protective eyewear 3202. Moreover, the adhesive 3214 provides the user the ability to adhere the attachment 3200 anywhere along the frame 3204 or other portion of the protective eyewear 3202, such as the lens 3206.

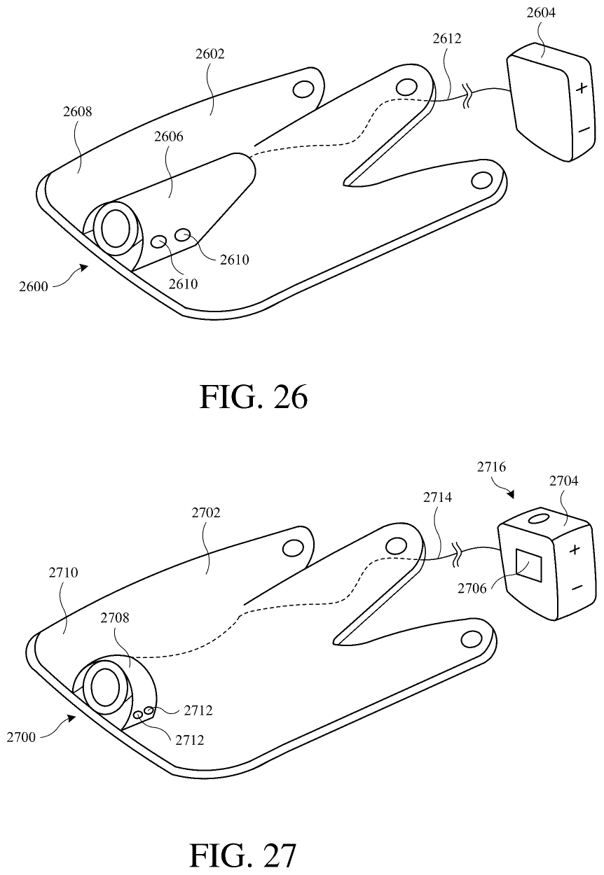

FIG. 33 illustrates another example of an attachment 3300. The attachment 3300 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to protective eyewear. For illustrative purposes, an arm 3302 of protective eyewear, such as a pair of sunglasses, is shown in FIG. 33.

The attachment 3300 may include a sleeve 3304. The sleeve 3304 may define a channel 3306 therein that is configured to receive at least a portion of the arm 3302. That is, the arm 3302 may be inserted into and through the sleeve 3304 such that the sleeve 3304 is positioned near a temple of a user when the user is wearing the protective eyewear, such as the protective eyewear 1902 shown in FIG. 19B. The sleeve 3304 may be flexible or semi-rigid to receive the arm 3302 therein. For example, the sleeve 3304 may be elastic so that the sleeve 3304 may stretch to accommodate a side of the arm 3302.

The sleeve 3304 may also define a receiving portion 3308 therein that is configured to receive a portion of the imaging system to secure the imaging system to the attachment 3300. By way of example, the imaging system may have an image capture device that includes a ball stud, which may be similar to the ball stud 3012 of the imaging system 3000 of FIG. 30. The ball stud may then be inserted into the receiving portion 3308 (e.g., a ball socket) to secure the image capture device to the sleeve 3304, at which point the attachment 3300 may be secured to the protective eyewear (e.g., to the arm 3302 of the protective eyewear).

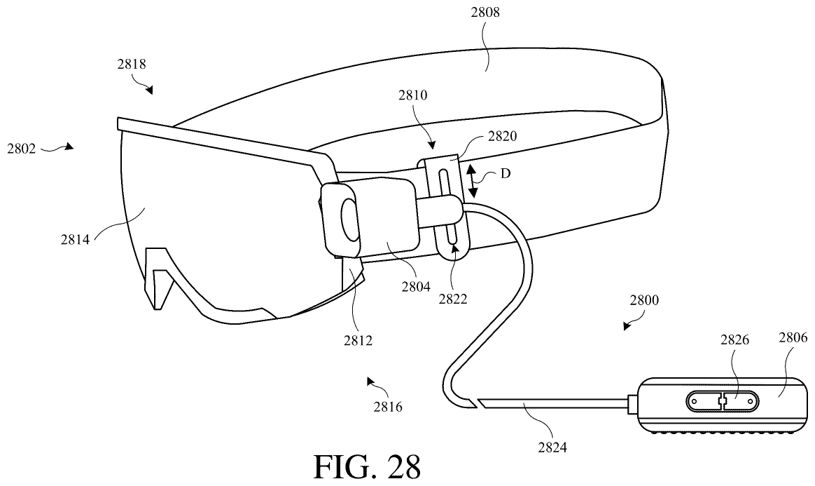

FIG. 34 illustrates another example of an attachment 3400. The attachment 3400 may be configured to removably secure an imaging system, such as the imaging system 3402 to protective eyewear. For example, the attachment 3400 may be configured to removably couple to opposing arms of a pair of glasses or sunglasses. The arms may be similar to the arms 1938 of the protective eyewear 1902 of FIG. 19B. Additionally, the imaging system 3402 may be similar to the imaging system 1600 of FIGS. 16A-16D, the imaging system 2800 of FIG. 28, or the imaging system 3000 of FIG. 30. For example, the imaging system 3402 may include an image capture device 3404 and a control module 3406 connected to one another via wiring 3408 therebetween. As such, the attachment 3400 may be used with any of the imaging systems described herein, such as the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30.

The attachment 3400 may include a first sleeve 3410 and a second sleeve 3412. The first sleeve 3410 and the second sleeve 3412 may be similar to the sleeve 3304 of the attachment 3300 of FIG. 33. For example, each of the sleeves may define a channel 3414 therein that is configured to receive a respective one of the arms of the protective eyewear. Each of the sleeves (e.g., the first sleeve 3410 and the second sleeve 3412) may further define a receiving portion 3416 therein that is configured to receive a portion of the imaging system 3402 to secure the imaging system 3402 to the attachment 3400. By way of example, the image capture device 3404 may include a ball stud, which may be similar to the ball stud 3012 of the imaging system 3000 of FIG. 30. The ball stud may then be inserted into the receiving portion 3416 (e.g., a ball socket) of the first sleeve 3410 or the second sleeve 3412 to secure the image capture device 3404 to the attachment 3400, at which point the attachment 3400 may be secured to the protective eyewear (e.g., to the arms of the protective eyewear). As such, the image capture device 3404 may be secured to either the first sleeve 3410 or the second sleeve 3412.

The first sleeve 3410 and the second sleeve 3412 may be connected to or integrally formed with a strap 3418. The strap 3418 may extend between the first sleeve 3410 and the second sleeve 3412 such that, when the attachment 3400 is secured to the protective eyewear, the strap 3418 may secure the protective eyewear around the head of the user. As shown in FIG. 34, the control module 3406 may be secured to the strap 3418 via a clip or other attachment means such that an entirety of the imaging system 3402 may be removably secured to the attachment 3400 to thereby couple the imaging system 3402 to the protective eyewear. Alternatively, or additionally, the control module 3406 may be secured elsewhere, such as within a pocket of the user's clothing (e.g., a jacket pocket).

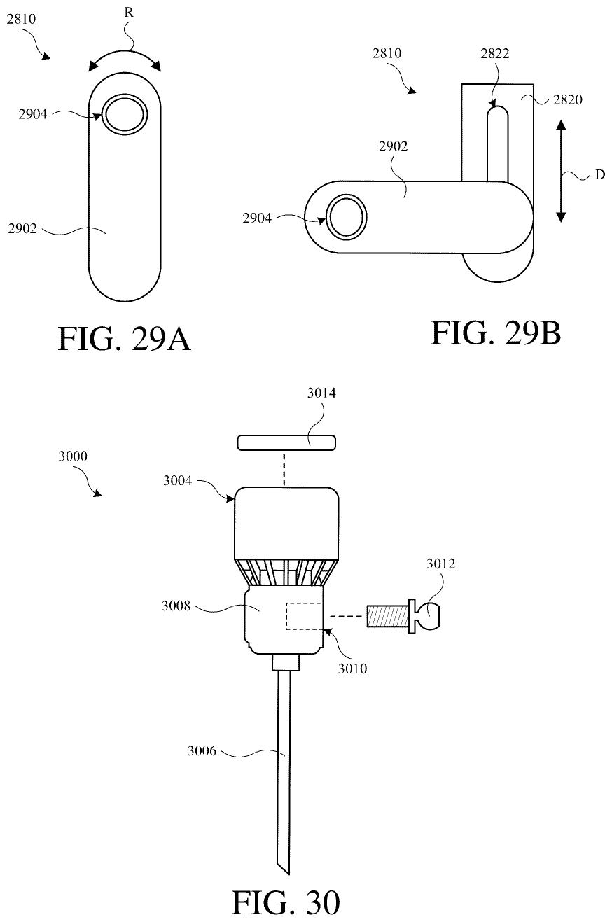

FIG. 35 is a perspective view of another example of an attachment 3500. The attachment 3500 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to various items, such as the protective eyewear, helmets, and visors disclosed herein. For example, the attachment 3500 may removably secure the imaging system to the strap 2808 of the protective eyewear 2802 or a helmet.

The attachment 3500 may include a base 3502. The base 3502 may define a receiving portion 3504 therein. For example, the base 3502 may include one or more fingers 3506 extend (e.g., projecting) from the base 3502 to form the receiving portion 3504 therebetween. The receiving portion 3504 may releasably engage (e.g., receive) a buckle 3508. For example, the buckle 3508 may include one or more engaging portions 3510 (e.g., fingers, teeth, clips, arms, etc.) that may be positioned in the receiving portion 3504 to engage the fingers 3506 of the base 3502. Thus, the buckle 3508 may be secured to the base 3502.

The buckle 3508 may further include a socket 3512 configured to receive a portion of the imaging system to secure the imaging system to the attachment 3500 (e.g., to the buckle 3508). By way of example, the imaging system may have an image capture device that includes a ball stud, which may be similar to the ball stud 3012 of the imaging system 3000 of FIG. 30. The ball stud may then be inserted into the socket 3512 (e.g., a ball socket) to secure the image capture device to the buckle 3508, at which point the buckle 3508 may be secured to the base 3502. The base 3502 may then be secured to an accessory or garment (e.g., protective eyewear, helmet, clothing, etc.) to thereby secure the imaging system to the accessory or garment. The base 3502 may include any connection means, such as an adhesive, clip, or magnet, which facilitate coupling of the base 3502 to the accessory or garment.

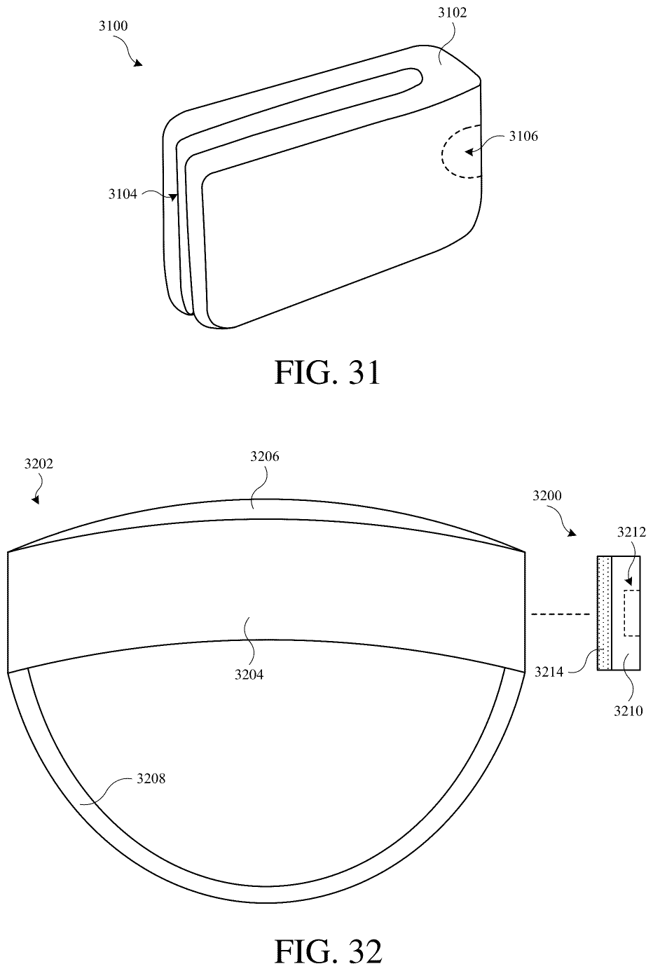

FIG. 36 is a perspective view of another example of an attachment 3600. The attachment 3600 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to various items, such as the protective eyewear, helmets, and visors disclosed herein. For example, the attachment 3600 may removably secure the imaging system to the frame 2812 of the protective eyewear 2802.

The attachment 3600 may include a base 3602. The base 3602 may be coupled to the aforementioned items (e.g., the frame 2812 of the protective eyewear 2802) via an adhesive 3604 disposed along a surface of the base 3602. The base 3602 may further include a socket 3606 configured to receive a portion of the imaging system to secure the imaging system to the attachment 3600. By way of example, the imaging system may have an image capture device that includes a ball stud, which may be similar to the ball stud 3012 of the imaging system 3000 of FIG. 30. The ball stud may then be inserted into the socket 3606 (e.g., a ball socket) to secure the image capture device to the base 3602, at which point the attachment 3600 may be secured to the aforementioned items (e.g., the frame 2812 of the protective eyewear 2802).

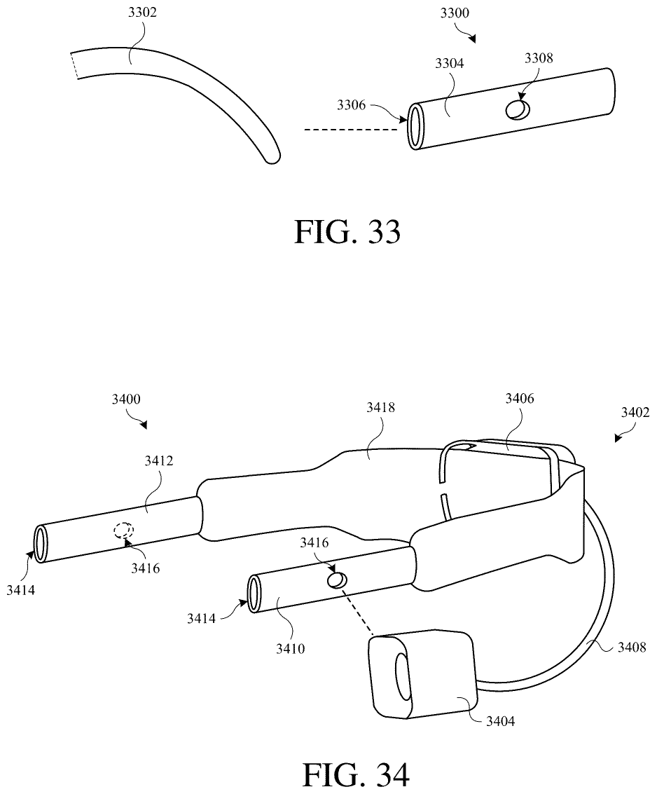

FIG. 37 is a perspective view of another example of an attachment 3700. The attachment 3700 may be configured to removably secure an imaging system, such as the imaging system 3702 to the body of the user. For example, the attachment 3700 may be or may include a strap 3704, which may be secured around a torso, shoulder, chest, or other region of the user's body using a clip 3706 connected to the strap 3704. As such, the strap 3704 may be releasably connected to the user's body via the clip 3706. The imaging system 3702 may thus be connected to the strap 3704 to thereby connect the imaging system 3702 to the user. The imaging system 3702 may be similar to the imaging system 1600 of FIGS. 16A-16D, the imaging system 2800 of FIG. 28, or the imaging system 3000 of FIG. 30. For example, the imaging system 3702 may include an image capture device 3708 and a control module 3710 connected to one another via wiring 3712 therebetween. As such, the attachment 3700 may be used with any of the imaging systems described herein, such as the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30

The strap 3704 may define one or more slots 3714 therein (e.g., cutouts, channels, openings, etc.), which may permit access to an interior region of the strap 3704. That is, the strap 3704 may define a channel or hollow interior portion therein that may be accessed via the slots 3714. As such, the imaging system 3702 may be at least partially routed through the interior portion of the strap 3704. By way of example, the image capture device 3708 may be coupled to the strap 3704, such as via a receiving portion 3720 (e.g., similar to those described above, such as a clip or another attachment means). The wiring 3712 of the imaging system 3702 may then be routed through the interior portion of the strap 3704 to avoid tangling or accidental damage to the wiring 3712. Moreover, the control module 3710 may be secured within a pocket 3716 of the strap 3704 such that the wiring 3712 and the control module 3710 of the imaging system 3702 may be substantially contained within the strap 3704. For example, the control module 3710 may be inserted into the pocket 3716 via an opening 3718 of the pocket 3716, whereby the wiring 3712 may be routed through the interior region of the strap 3704 (e.g., via the slots 3714) between the image capture device 3708 and the control module 3710. As such, substantially all of the imaging system 3702 may be located within the strap 3704 other than the image capture device 3708.

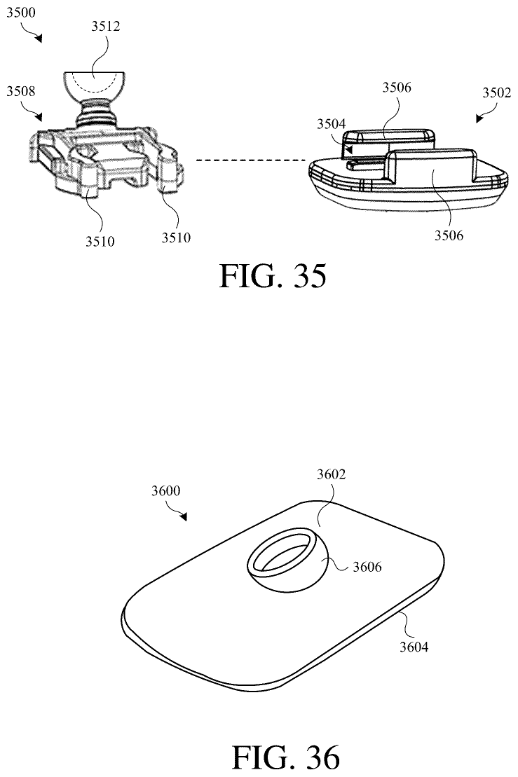

FIG. 38A a front view of another example of an attachment 3800. FIG. 38B illustrates a side view of the attachment 3800. The attachment 3800 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to various items, such as the protective eyewear, helmets, and visors disclosed herein. For example, the attachment 3800 may removably secure the imaging system to the strap 2808 of the protective eyewear 2802.

The attachment 3800 may include a clip portion 3802 that substantially forms an overall size and/or shape of the attachment 3800. The clip portion 3802 may define a channel 3804 therein that may receive a portion of the various items discussed above (e.g., the strap 2808 of the protective eyewear 2802). Teeth, knurling, or other frictional surfaces may be present within the channel 3804 to further improve engagement between the attachment 3800 and a portion of the item received therein.

The attachment 3800 may further include a magnetic portion 3806, which may be magnetically coupled to one or more surfaces of the clip portion 3802. That is, the clip portion 3802 may be or may include a magnetic region that may magnetically attract the magnetic portion 3806 to couple the magnetic portion 3806 to the clip portion 3802. The magnetic portion 3806 may be a secondary plate or bracket that is coupled to the clip portion 3802. For example, the magnetic portion 3806 may include or may define a receiving portion 3808 that is configured to secure an imaging system to the clip portion 3802.

By way of example, FIG. 38B illustrates an example of an imaging system 3810 coupled to the attachment 3800. The imaging system 3810 may be similar to the imaging system 1600 of FIGS. 16A-16D, the imaging system 2800 of FIG. 28, or the imaging system 3000 of FIG. 30. As shown in FIG. 38B, an image capture device 3812 may be coupled (e.g., mechanically, such as via an engaging portion of the image capture device 3812 being received by the receiving portion 3808, or magnetically) to the receiving portion 3808 such that the magnetic portion 3806 may magnetically couple the image capture device 3812 to the clip portion 3802. Wiring 3814 of the imaging system 3810 may be routed through a channel 3816 defined by the magnetic portion 3806 to position the wiring 3814 in a desired manner. As discussed above, the wiring 3814 may connect the image capture device to a control module of the imaging system 3810. Once the image capture device 3812 is secured to the clip portion 3802 via the magnetic portion 3806, the attachment 3800 may be secured to the aforementioned items (e.g., the strap 2808 of the protective eyewear 2802) via the clip portion 3802.

For further adjustability of a position of the image capture device 3812, the receiving portion 3808 may be coupled to the magnetic portion 3806 via a joint 3818 and/or a hinge 3820. The joint 3818 and/or the hinge 3820 may facilitate movement of the image capture device 3812 and the receiving portion 3808 with respect to the magnetic portion 3806. For example, the joint 3818 may be a ball joint that allows for pivotal movement of the image capture device 3812 about the joint 3818. Similarly, the hinge 3820 may facilitate pivoting of the receiving portion 3808 with respect to the magnetic portion 3806. As such, a field of view of the image capture device 3812 may be adjusted once the attachment 3800 is secured to an item (e.g., the protective eyewear 2802).

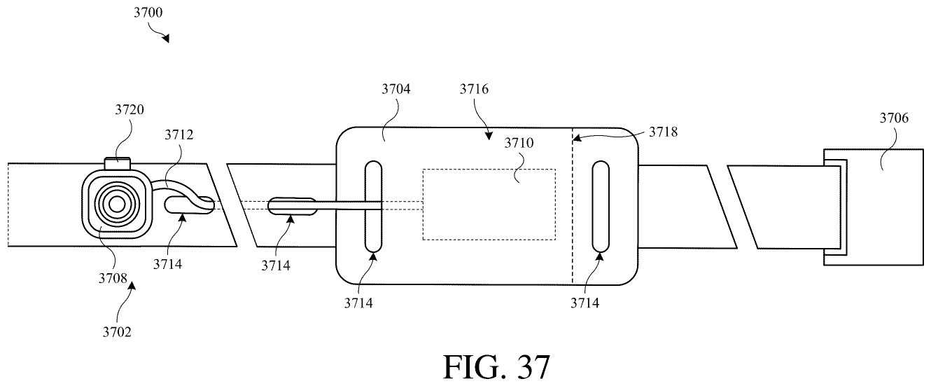

FIG. 39 illustrates another example of an attachment 3900. The attachment 3900 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to various items, such as the protective eyewear, helmets, and visors disclosed herein. For example, the attachment 3900 may removably secure the imaging system to a pole, such as the pole 3902 shown in FIG. 39.

The attachment 3900 may include one or more fingers 3904 defining a through-hole 3906 extending through at least a portion of the fingers 3904. The fingers 3904 may be configured to interleave with fingers 3908 of the pole 3902 to secure the attachment 3900 to the pole 3902. For example, the fingers 3908 of the pole 3902 may also define a through-hole 3910 extending through at least a portion of the fingers 3908 of the pole 3902. When the fingers 3904 of the attachment 3900 are positioned between the fingers 3908 of the pole 3902, the through-hole 3910 of the pole 3902 may be aligned with the through-hole 3906 of the attachment 3900 such that a fastener (e.g., bolt, pin, screw, etc.) may extend through both the through-hole 3906 of the attachment 3900 and the through-hole 3910 of the pole 3902 to secure the attachment 3900 to the pole 3902. Such a connection may also define pivot joint between the pole 3902 and the attachment 3900.

The attachment 3900 may further include a receiving portion 3912 that is configured to secure an imaging system to the attachment 3900. For example, the imaging system (e.g., an image capture device of the imaging system) may be coupled to the receiving portion 3912 in a mechanical manner, such as via an engaging portion of the image capture device being received by the receiving portion 3912, or magnetically, to secure the imaging system to the attachment 3900.

For further adjustability of a position of the image capture device, the receiving portion 3912 may be coupled to the fingers 3904 via a joint 3914. The joint 3914 may facilitate movement of the image capture device and the receiving portion 3912 with respect to the fingers 3904. For example, the joint 3914 may be a ball joint that allows for pivotal movement of the image capture device about the joint 3914. As such, a field of view of the image capture device may be adjusted once the attachment 3900 is secured to the pole 3902.

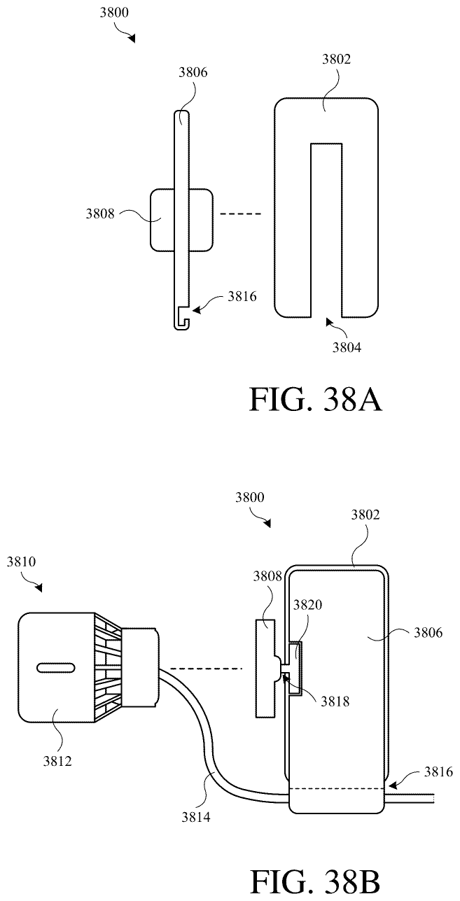

FIG. 40 illustrates another example of an attachment 4000. The attachment 4000 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) between the teeth of the user. For example, the attachment 4000 may include a mouthpiece 4002, which may be bitten down upon by the user to secure the attachment 4000 between the teeth of the user.

The attachment 4000 may further include a receiving portion 4004 that is configured to secure an imaging system to the attachment 4000. For example, the imaging system (e.g., an image capture device of the imaging system) may be coupled to the receiving portion 4004 in a mechanical manner, such as via an engaging portion of the image capture device being received by the receiving portion 4004, or magnetically, to secure the imaging system to the attachment 4000.

For further adjustability of a position of the image capture device, the receiving portion 4004 may be coupled to the mouthpiece 4002 via a joint 4006. The joint 4006 may facilitate movement of the image capture device and the receiving portion 4004 with respect to the mouthpiece 4002. For example, the joint 4006 may be a ball joint that allows for pivotal movement of the image capture device about the joint 4006. As such, a field of view of the image capture device may be adjusted once the attachment 4000 is secured between the teeth of the user.

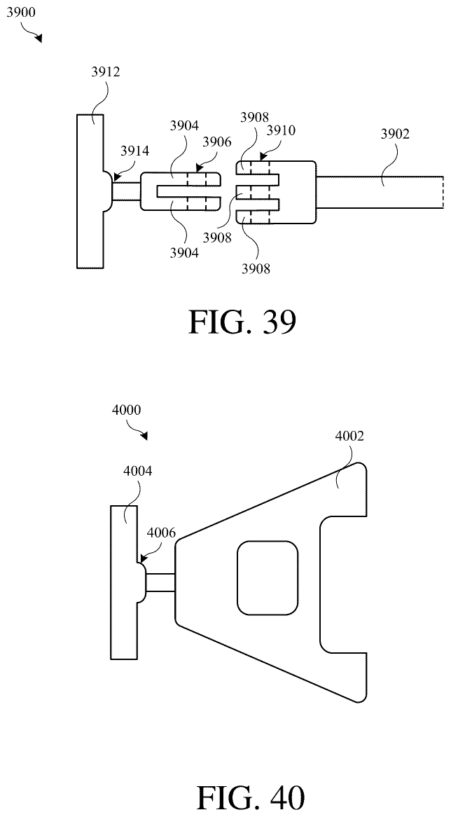

FIG. 41 is a perspective view of another example of an attachment 4100. The attachment 4100 may be configured to removably secure an imaging system (e.g., the imaging system 1500 of FIGS. 15A-15C, the imaging system 1600 of FIGS. 16A-16D, the imaging system 19A-19B, the imaging system 2800 of FIG. 28, or the imaging system 3000 of FIG. 30) to various items, such as the protective eyewear, helmets, and visors disclosed herein. For example, the attachment 4100 may removably secure the imaging system to the strap 2808 of the protective eyewear 2802.

The attachment 4100 may include a clip portion 4102 that substantially forms an overall size and/or shape of the attachment 4100. The clip portion 4102 may define a channel 4104 (e.g., slot, groove, notch, cutout, etc.) therein that may receive a portion of the various items discussed above (e.g., the strap 2808 of the protective eyewear 2802). Teeth, such as the teeth 4106, knurling, or other frictional surfaces may be present within the channel 4104 to further improve engagement between the attachment 4100 and a portion of the item received therein. The attachment 4100 may also define a receiving portion 4108 that is configured to receive a portion of the imaging system to secure the imaging system to the attachment 4100. By way of example, the imaging system may have an image capture device that includes a ball stud, which may be similar to the ball stud 3012 of the imaging system 3000 of FIG. 30. The ball stud may then be inserted into the receiving portion 4108 (e.g., a ball socket) to secure the image capture device to the clip portion 4102, at which point the attachment 4100 may be clipped to the desired item. For example, the clip portion 4102 may include or define a pivot 4110 such that the channel 4104 may be opened to receive the item therebetween. The pivot 4110 may be biased (e.g., spring-loaded or elastic) such that channel 4104 may be closed around the item and the teeth 4106 may grip the item therebetween to secure the imaging system to the item.

For further adjustability of a position of the image capture device, the receiving portion 4108 may be coupled to the clip portion 4102 via a joint 4112. The joint 4112 may facilitate movement of the image capture device and the receiving portion 4108 with respect to the clip portion 4102. For example, the joint 4112may be a ball joint that allows for pivotal movement of the image capture device about the joint 4112. As such, a field of view of the image capture device may be adjusted once the attachment 4100 is secured to the item (e.g., the strap 2808 of the protective eyewear 2802).

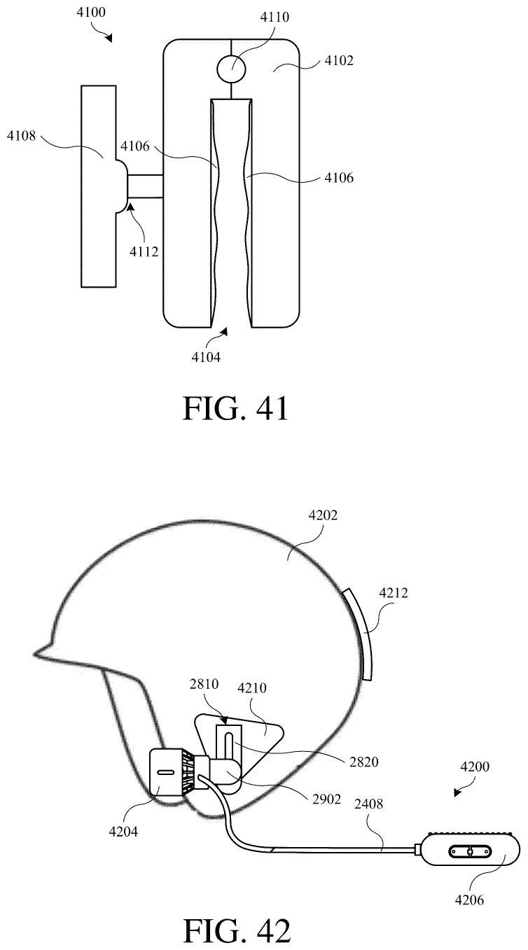

FIG. 42 illustrates a side view of an example of an imaging system 4200 coupled to a helmet 4202. The imaging system 4200 may be similar to the imaging system 1600 of FIGS. 16A-16D, the imaging system 2800 of FIG. 28, or the imaging system 3000 of FIG. 30. For example, the imaging system 4200 may include an image capture device 4204 and a control module 4206 connected to one another via wiring 2408 therebetween.

As shown in FIG. 42, the image capture device 4204 may be removably coupled to an earmuff 4210 of the helmet 4202 via an attachment, such as the attachment 2810 of FIGS. 28-29B. For example, the clip portion 2820 of the attachment 2810 may be clipped to a portion of the earmuff 4210 to secure the image capture device 4204 to the helmet 4202. As such, the arm 2902 of the attachment 2810, which secures the image capture device 4204, may be rotated with respect to the clip portion 2820 and/or may be slid along the slot 2822 of the clip portion 2820 to position the image capture device 4204 in a desired location. It should also be noted that any one of the attachments described above (e.g., the attachments shown in FIGS. 31-41) may be suitable to secure the image capture device 4204 to the helmet 4202. Additionally, the control module 4206 may be secured elsewhere, such as within a pocket of a coat of the user, or may be directed coupled to the helmet 4202. For example, the control module 4206 may be secured at an attachment point 4212 along an exterior surface of the helmet 4202 via mechanical engagement (e.g., a hook-and-loop fastener) and/or an adhesive. As such, substantially all of the imaging system 4200 may be secured to the helmet 4202.

The methods and techniques of the imaging system described herein, or aspects thereof, may be implemented by or using an image capture apparatus, or one or more components thereof, such as the image capture apparatus 100 shown in FIG. 1A-1B, the image capture apparatus 200 shown in FIG. 2A-2B, the image capture apparatus 300 shown in FIG. 3, the image capture apparatus 400 shown in FIG. 4A-4B, or the image capture apparatus 500 shown in FIG. 5. The methods and techniques of the imaging system described herein, or aspects thereof, may be implemented by or using an image capture device, such as the image capture device 104 shown in FIG. 1A-1B, one or more of the image capture devices 204, 206 shown in FIG. 2A-2B, one or more of the image capture devices 304, 306 shown in FIG. 3, the image capture device 404 shown in FIG. 4A-4B, or an image capture device of the image capture apparatus 500 shown in FIG. 5. The methods and techniques of the imaging system described herein, or aspects thereof, may be implemented by or using an imaging system, including the imaging system 600 shown in FIGS. 6A-6B, the imaging system 700 shown in FIGS. 7A-7C, the system 800 shown in FIG. 8, the imaging system 900 shown in FIG. 9, the imaging system 1000 shown in FIGS. 10A-10B, the imaging system 1500 of FIGS. 15A-15C the imaging system 1600 shown in FIGS. 16A-16D, the imaging system 1900 shown in FIGS. 19A and 19B, the imaging system 2000 shown in FIGS. 20-23, the imaging system 2500 shown in FIG. 25, the imaging system 2600 shown in FIG. 26, the imaging system 2700 shown in FIG. 27, the imaging system 2800 shown in FIG. 28, the imaging system 3000 shown in FIG. 30, the imaging system 3402 shown in FIG. 34, the imaging system 3702 shown in FIG. 37, the imaging system 3810 shown in FIG. 38B, or the imaging system 4200 shown in FIG. 42.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An imaging system for protective eyewear, the imaging system comprising:
an image capture device configured for removable coupling to and from a frame of the protective eyewear, wherein the image capture device includes a connecting portion that extends into the frame to removably couple the image capture device to the frame; and
a control module configured to power the image capture device and for removable coupling to and from a strap of the protective eyewear, wherein the control module is spaced apart from the image capture device when the image capture device and the control module are coupled to the protective eyewear.

2. The imaging system of claim 1, wherein the image capture device includes:
a lens assembly located at least partially within a body of the image capture device;
one or more microphones;
one or more speakers; and
a light configured to illuminate an area external to the image capture device.

3. The imaging system of claim 2, wherein the protective eyewear includes:
a lens secured within the frame, wherein the lens assembly is configured to extend outward from the protective eyewear beyond an entirety of an exterior surface of the lens.

4. The imaging system of claim 1, wherein the strap is coupled to the frame and configured to secure the protective eyewear to a head of a user.

5. The imaging system of claim 1, wherein the control module includes a user interface to control operation of the image capture device.

6. The imaging system of claim 1, wherein the control module includes one or more clip portions that are configured to secure the control module to the strap, and wherein a position of the control module along the strap is adjustable via the clip portions.

7. The imaging system of claim 6, wherein the control module includes a housing, and wherein the one or more clip portions are formed with the housing.

8. The imaging system of claim 7, wherein the housing defines a cavity therein that is accessible via an openable access panel of the housing, and wherein a power module is disposed in the cavity of the housing and configured to power the image capture device.

9. The imaging system of claim 1, wherein the control module includes one or more contacts that are configured to electrically connect an accessory to the control module.

10. The imaging system of claim 9, wherein the accessory is at least one of a cellular network module, a power module, or a peer-to-peer communication module.

11. The imaging system of claim 9, wherein the one or more contacts are configured to electrically and mechanically connect the accessory to the control module.

12. The imaging system of claim 1, wherein the connecting portion is configured to rotatably couple the image capture device to the frame such that the image capture device is configured to rotate with respect to the frame when the image capture device is coupled to the frame.

13. The imaging system of claim 12, wherein the connecting portion includes one or more teeth that are configured to mesh with teeth of the frame and establish geared rotation of the image capture device with respect to the frame.

14. The imaging system of claim 13, wherein the frame defines a receiving portion therein, and the teeth of the frame are disposed within the receiving portion such that, when the connecting portion is inserted into the receiving portion, the teeth of the receiving portion mesh with the teeth of the connecting portion.

15. An imaging system for protective eyewear, the imaging system comprising:
an image capture device configured for removable coupling to and from a frame of the protective eyewear;
a control module configured to power the image capture device via wiring connecting the control module to the image capture device; and
a strap configured for removable coupling to and from the frame of the protective eyewear, wherein the control module is removably coupled to the strap and spaced apart from the image capture device when the image capture device is coupled to the frame of the protective eyewear.

16. The imaging system of claim 15, wherein the wiring is routed through an interior channel defined by the strap and located between the image capture device and the control module.

17. The imaging system of claim 15, wherein the strap is configured to be removably coupled to the frame of the protective eyewear and interchangeable with arms that are configured to be removably coupled to the frame.

18. The imaging system of claim 15, wherein the strap is configured to removably couple to one or more quick-release mechanisms of the frame of the protective eyewear.

19. The imaging system of claim 15, wherein the strap is configured to secure the protective eyewear to a head of a user, wherein the image capture device is configured for positioning near a left side or right side of the head of the user, and wherein the control module is configured for positioning near a back of the head of the user.

20. The imaging system of claim 15, wherein the protective eyewear is a pair of safety glasses or sunglasses.
